(19) United States
(12) Patent Application Publication
(10) Pub. No.: US 2025/0323317 A1
(43) Pub. Date: Oct. 16, 2025

(54) KAOLINITE NANOPLATELET GEL ELECTROLYTES, AND FABRICATING METHOD AND APPLICATIONS OF SAME

(71) Applicant: NORTHWESTERN UNIVERSITY, Evanston, IL (US)

(72) Inventors: Mark C. Hersam, Wilmette, IL (US); Cory M. Thomas West, Evanston, IL (US); Davy Zeng, Evanston, IL (US)

(21) Appl. No.: 19/172,791

(22) Filed: Apr. 8, 2025

Related U.S. Application Data
(60) Provisional application No. 63/634,544, filed on Apr. 16, 2024.

(51) Int. Cl. H01M 10/0564; C01B 33/40; H01M 10/052; H01M 10/42

(52) U.S. Cl. CPC H01M 10/0564; C01B 33/40; H01M 10/052; H01M 10/4235; C01P 2002/76; C01P 2002/82; C01P 2002/85; C01P 2002/88; C01P 2004/03; C01P 2004/04; C01P 2004/24; C01P 2006/12; C01P 2006/40; H01M 2300/0025; H01M 2300/0085; H01M 2300/0091

(57) ABSTRACT

One aspect of the invention relates to a method for scalable production of kaolinite nanoplatelets (KNPs) comprising shear-mixing a mixture of bulk kaolinite with ethanol or water and a dispersing agent; centrifuging the shear-mixed mixture to sediment and remove unexfoliated bulk kaolinite, and obtain a supernatant containing the KNPs; flocculating the supernatant with deionized (DI) water or sodium chloride solution, collecting and drying flocculated KNPs; and annealing the flocculated KNPs to decompose and volatilize the remaining dispersing agent, thereby resulting in a partial coating of oxidized amorphous carbon on the surface of the KNPs.

### CROSS-REFERENCE TO RELATED PATENT APPLICATION

This application claims priority to and the benefit of U.S. Provisional Patent Application Ser. No. 63/634,544, filed Apr. 16, 2024, which is incorporated herein in its entirety by reference.

### STATEMENT AS TO RIGHTS UNDER FEDERALLY-SPONSORED RESEARCH

This invention was made with government support under grant numbers CMMI-2037026, DGE-1842165 and DMR-2308691 awarded by the National Science Foundation. The government has certain rights in the invention.

### FIELD OF THE INVENTION

The present invention generally relates to materials, particularly to Kaolinite nanoplatelet gel electrolytes, fabricating methods and applications of the same.

### BACKGROUND OF THE INVENTION

The background description provided herein is to present the context of the invention generally. The subject matter discussed in the background of the invention section should not be assumed to be prior art merely due to its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Lithium-ion batteries (LIBs) have emerged as the leading technology for the portable electronics, transportation, and grid-level energy storage markets. However, current commercial LIBs are reaching practical limitations in their energy density and are susceptible to catastrophic failure resulting from the use of flammable liquid electrolytes. As a result, significant effort has been devoted to developing solid-state electrolytes (SSEs) that can resolve both challenges. In particular, SSEs constructed with nonflammable constituents can significantly improve cell safety compared to traditional carbonate-based liquid electrolytes. Moreover, SSEs that enable stable operation of next-generation negative electrodes, such as lithium metal, have the potential to provide significantly higher energy density than traditional LIBs. However, currently available SSEs employ materials that are cost-prohibitive or not earth-abundant, limiting their manufacturing scalability and environmental sustainability.

Clay-based nanocomposite electrolytes offer an enticing route to solid or quasi-solid electrolytes since they utilize earth-abundant and environmentally-friendly clay materials that are geographically well-distributed. In addition, clays provide several desirable characteristics in an electrolyte matrix including high thermal stability, low electrical conductivity, and wide electrochemical stability window. Furthermore, when exfoliated, their structured aluminosilicate layers provide high gravimetric surface area that result in robust nanocomposite mechanical properties. The most common clays utilized are montmorillonite, vermiculite, and halloysite for nano-fillers or matrices in polymer, polymer gel, and ionogel electrolytes. In these cases, the nano-clay provides mechanical support, increasing the electrolyte mechanical modulus and decreasing polymer crystallinity that enhances ionic conductivity. Despite the breadth of demonstrated clay nanocomposite electrolytes, the most naturally abundant clay variety, kaolinite, has rarely been utilized. The 1:1 structure of silica and alumina layers within bulk kaolinite results in strong hydrogen bonding between the layers making exfoliation difficult relative to other clay varieties. Although kaolinite nanocomposites produced through chemical intercalation have been demonstrated, this process is time-intensive and limited to a small subset of molecules, restricting potential applications. Only one reported system to date has shown liquid-phase exfoliation of kaolinite, albeit with the assistance of a large fraction of graphene oxide (GO) dispersing agent (i.e., 5:1 GO:kaolinite) and no reported yield for the process.

Therefore, a need remains for a highly scalable kaolinite exfoliation process that will enable broader use of kaolinite in SSEs and related clay nanocomposite applications.

### SUMMARY OF THE INVENTION

In one aspect, this invention relates to a method for scalable production of kaolinite nanoplatelets (KNPs), comprising shear-mixing a mixture of bulk kaolinite with ethanol or water and a dispersing agent; centrifuging the shear-mixed mixture to sediment and remove unexfoliated bulk kaolinite, and obtain a supernatant containing the KNPs; flocculating the supernatant with deionized (DI) water or sodium chloride solution, collecting and drying flocculated KNPs; and annealing the flocculated KNPs to decompose and volatilize the remaining dispersing agent, thereby resulting in a partial coating of oxidized amorphous carbon on the surface of the KNPs.

In one embodiment, said flocculating the supernatant with deionized (DI) water is performed at a mass ratio of supernatant:DI water being about 1.5:1 to 1.75:1.

In one embodiment, said annealing the flocculated KNPs is performed in air at about 350-450° C. for 4 h.

In one embodiment, the dispersing agent is adapted to minimize re-agglomeration of the aluminosilicate layers.

In one embodiment, the dispersing agent comprises ethyl cellulose (EC), carboxymethyl cellulose (CMC), hydroxyethyl cellulose (HEC), hydroxypropyl methylcellulose (HPMC), hydroxypropyl cellulose (HPC), cellulose acetate (CA), or polyethylene glycol (PEG).

In one embodiment, yield of the KNPs from the bulk kaolinite after liquid phase exfoliation has an approximately linear relationship with a starting ratio of the EC to the bulk kaolinite.

In one embodiment, the starting ratio of the EC to the bulk kaolinite is less than about 0.5:1 (EC:kaolinite).

In one embodiment, the method further comprises recycling the sediment of unexfoliated bulk kaolinite, which generates an increase in yield of the KNPs about 20% compared to using fresh bulk kaolinite alone.

In one embodiment, the KNPs have a hexagonal plate-like morphology.

In one embodiment, the KNPs have an average lateral size and thickness of about 190±50 nm and about 17±5 nm, respectively.

In one embodiment, the distribution of the nanoplatelet thicknesses has a median thickness of about 3 nm with about 35% of the KNPs having a thickness less than about 2 nm.

In one embodiment, the XRD diffraction pattern for the KNPs shows a significantly diminished (001) reflection when compared to the (002) reflection, thereby verifying a significant disruption of the stacking periodicity of kaolinite layers following exfoliation.

In one embodiment, Fourier-transform infrared spectroscopy (FTIR) spectra of the KNPs have a blue shift in vibrational frequency in the hydroxyl and Si—O peaks compared to that of the bulk kaolinite.

In one embodiment, all peaks in the KNP spectrum can be mapped to the bulk kaolinite structure with the exception of a broad peak at 1440 cm⁻¹, which is attributed the C—O and C—H stretching from the annealed EC on the nanoplatelet surface.

In one embodiment, the KNPs have the Brunauer-Emmett-Teller (BET) surface area more than doubled from about 9.7 m² g⁻¹ to about 24 m² g⁻¹ following kaolinite exfoliation.

In one embodiment, the KNPs have excellent thermal stability with measurable mass loss only detectable at temperatures exceeding about 500° C.

In one embodiment, the KNPs have limited kaolinite nanoscroll morphology.

In one embodiment, the KNPs have high specific surface area relative to that of the bulk kaolinite, which facilitates strong gelation with liquid electrolytes at low mass loadings.

In one embodiment, the KNPs is dispersible with a liquid electrolyte to form a high-performance gel electrolyte.

In another aspect, this invention relates to kaolinite nanoplatelets (KNPs), produced according to the above method.

In a further aspect, this invention relates to a nanocomposite gel electrolyte, comprising a succinonitrile-based (SN), dinitrile-based, ether-based, ethylene carbonate-based, propylene carbonate-based or ionic liquid-based liquid electrolyte; and kaolinite nanoplatelets (KNPs) mixed with the liquid electrolyte to form a KNP-SN gel electrolyte, denoted as KNP(x %)-SN, wherein x is a mass percentage of the KNPs in the KNP-SN gel electrolyte, wherein the KNPs are produced according to the method of claim 1.

In one embodiment, the KNP-SN gel electrolyte possesses a range of superlative properties including high room-temperature ionic conductivity (1 mS cm⁻¹), stiff storage modulus (>10 MPa), wide electrochemical stability window (4.5 V vs. Li/Li⁺), and excellent thermal stability (>100° C.).

In one embodiment, the liquid electrolyte comprises the electrolyte solvent mixed with lithium salts lithium bis(trifluoromethanesulfonyl)imide (LiTFSI), lithium tetrafluoroborate (LiBF₄)), lithium bis(fluorosulfonyl)imide (LiFSI), or lithium hexafluorophosphate (LiPF₆), along with a film-forming additive, fluoroethylene carbonate (FEC).

In one embodiment, FTIR spectra of the KNP-SN gel electrolyte have a blue shift of the interlayer hydroxyl group and Si—O vibrational bands as the relative SN content increases in the KNP-SN gel electrolyte.

The nanocomposite gel electrolyte of claim 21, being usable as both an electrolyte and a separator within LMB cells by preventing short-circuiting and inhibiting lithium dendrite growth.

In one embodiment, the KNP-SN gel electrolyte has a quasi-solid nature that is confirmed by the storage modulus being consistently higher than the loss modulus across a wide range of shear frequencies.

In one embodiment, the KNP-SN gel electrolyte possesses a high ionic conductivity of 1 mS cm⁻¹ at 20° C.

In one embodiment, the lithium transference number (TLi) for the KNP-SN gel electrolyte is that 0.6.

In one embodiment, FTIR spectra of the KNP-SN gel electrolyte shows the blue shifting of the peaks associated with the asymmetric stretching of the —CF₃ groups within the TFSI anion and the carbonyl group of FEC as KNP content is increased, wherein the blue shifting is due to hydrogen bonding with exposed hydroxyl groups on the surface of the KNP.

In one embodiment, as the KNP loading increases, the relative area of the SN—Li⁺ peak decreases, indicating that lithium is being solvated by other species, likely the exposed silica surface of the KNPs.

In one embodiment, the combined effect of Li salt interactions with the KNP surface accounts for the increase in lithium transference number of the KNP-SN gel compared to the SN-only liquid electrolyte.

In one embodiment, the KNP-SN gel electrolyte has an electronic conductivity of about 6.30×10⁻¹⁰ S cm⁻¹, which is sufficiently insulating for solid-state electrolytes (SSEs) in energy storage applications.

In one embodiment, the KNP-SN gel reaches 2% mass loss at 100° C. (T_{2%}), which represents significantly higher thermal stability than traditional carbonate electrolytes.

In one embodiment, the KNP-SN gel is electrochemically stable with lithium metal over a range of potentials up to 4.5 V vs. Li/Li⁺.

In one embodiment, the KNP-SN gel electrolyte is compatible for energy-dense LMBs, the electrochemical stability window was evaluated at both high and low potentials relative to Li/Li⁺.

In one aspect, this invention relates to an electrochemical device, comprising a positive electrode; a negative electrode; and a nanocomposite gel electrolyte disposed between the positive electrode and the negative electrode.

In one embodiment, the nanocomposite gel electrolyte is a KNP-SN gel electrolyte comprising a succinonitrile (SN) liquid electrolyte and kaolinite nanoplatelets (KNPs) mixed with the SN liquid electrolyte.

In one embodiment, the electrochemical device is a lithium metal battery (LMB).

In one embodiment, the positive electrode is an LiFePO₄ (LFP), Li₄TisO₁₂ (LTO), LiNi_{0.8}Co_{0.15}Al_{0.05}O₂ (NCA), LiNi_{0.33}Mn_{0.33}Co_{0.33}O₂ (NMC111), LiNi_{0.5}Mn_{0.3}Co_{0.2}O₂ (NMC532), LiNi_{0.6}Mn_{0.2}Co_{0.2}O₂ (NMC622), LiNi_{0.8}Mn_{0.1}Co_{0.1}O₂ (NMC811), LiNiO₂ (LNO), LiMn₂O₄ (LMO), or LiCoO₂ (LCO) positive electrode, and the negative electrode is a lithium metal electrode.

In one embodiment, when the positive electrode is with a high active material loading (>10 mg cm⁻²), both cell types achieve high discharge capacities of 160 mAh g⁻¹ and 200 mAh g⁻¹ at 0.1 C (0.18-0.2 mA cm⁻²) for LFP|Li and NCA|Li, respectively.

In one embodiment, the LMB has excellent rate capability and >56% capacity utilization compared to 0.1 C.

In one embodiment, the LMB has stable electrochemical operation.

In one embodiment, the LMB reaches 125 cycles with a capacity retention of 94% and 80% for LFP|Li and NCA|Li, respectively.

In one embodiment, the LMB has an improvement in rate of 12% and 22% for the LFP and NCA cells, respectively at 60° C.

The electrochemical device of claim 36, wherein the LMBs achieve excellent performance, particularly >56% capacity utilization up to a current density of 2 mA cm⁻².

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows a schematic illustration of kaolinite nanoplatelet (KNP) electrolyte production including: liquid phase exfoliation of natural kaolinite with ethanol and ethyl cellulose (EC) using a high shear radial mixer producing exfoliated KNPs; high-temperature annealing to remove residual EC; KNP gel electrolyte synthesis with a succinonitrile (SN) liquid electrolyte.

FIG. 2 shows characterization of kaolinite nanoplatelets (KNPs). (panel a) Scanning electron microscopy (SEM) images of bulk kaolinite and exfoliated KNP powders. (panel b) X-ray diffraction (XRD) of bulk kaolinite and exfoliated KNP powders. (panel c) FTIR spectra of bulk kaolinite and exfoliated KNP powders. Full spectra and peak assignments are provided in FIG. 12 and Table 1. (panel d) Nitrogen isotherms of bulk kaolinite and exfoliated KNP powders with the reported Brunauer-Emmett-Teller (BET) surface area. The BET analysis parameters are provided in Table 2.

FIG. 3 shows kaolinite nanoplatelet (KNP)-succinonitrile (SN) gel electrolyte. (panel a) Scanning electron microscopy (SEM) image of the KNP-SN gel. (panel b) FTIR spectra of the hydroxyl vibrational bands of KNP-SN gel electrolytes showing a blue shift of interlayer hydroxyl groups as additional liquid electrolyte is added. (panel c) Rheological properties of the KNP-SN gel electrolyte at different loadings of KNP compared to a bulk kaolinite-SN gel. (panel d) Chronoamperometry (CA) and electrochemical impedance spectroscopy (EIS) of a Li|Li cell were used to determine the lithium transference number (Tu) of the KNP-SN gel. (panel e) Flame test comparison of the KNP-SN gel and a traditional liquid electrolyte on a 2 cm diameter glass fiber separator.

FIG. 4 shows electrochemical performance of the KNP-SN gel electrolyte in lithium metal battery cells at room temperature (22° C.). (panels a and d) Rate capability of LFP/NCA|Li cells with KNP(45%)-SN gel electrolyte at various charge/discharge rates and (panels b and e) corresponding voltage profiles. The active material loading for the LFP and NCA cells used for rate testing is 10-11 mg cm⁻². (panel c and f) Cycle stability performance of LFP/NCA|Li cells with KNP(45%)-SN gel electrolyte at 0.5 mA cm⁻² charge/discharge rate and 5-6 mg cm⁻² active material loading.

FIG. 5 shows yield of kaolinite nanoplatelets (KNPs) from bulk kaolinite after liquid phase exfoliation at various starting ratios of ethyl cellulose (EC) to kaolinite.

FIG. 6 shows thermogravimetric analysis (TGA) of KNP+ethyl cellulose (EC) powder mixtures produced from liquid-phase shear mixing. The TGA profile is shown for various starting ratios of bulk kaolinite to EC. EC decomposes at ˜250° C., and kaolinite undergoes dehydroxylation at ˜500° C. All samples were tested in a nitrogen environment, and a ramp rate of 10° C. min⁻¹ was used.

FIG. 7 shows transmission electron micrograph (TEM) of a KNP highlighting the amorphous carbon coating left after annealing the KNP-ethyl cellulose (EC) product of liquid phase exfoliation.

FIG. 8 shows X-ray photoelectron spectroscopy (XPS) of exfoliated KNPs. (a) XPS survey spectrum showing the major constituents of Al, Si, and O, impurities such as K, and the oxidized amorphous carbon coating left by annealing the KNP and ethyl cellulose (EC) mixture. (b) The C Is spectrum is deconvoluted into component peaks at 284.8 cV, ˜286 eV, and ˜289 cV, representing C—C, C—O, and O—C═O, respectively.

FIG. 9 shows energy dispersive spectroscopy (EDS) mapping of an exfoliated KNP. (a) Transmission electron microscopy (TEM) bright field image of a KNP particle with spectrum image location indicated. (b) EDS mapping of the KNP particle edge with each element shown separately (C, Al, Si, and O), revealing the carbon coating left by the annealing of ethyl cellulose (EC).

FIG. 10 shows (panel a) High angle annular dark field (HAADF) and (panel b) bright field transmission electron micrographs gathered via TEM of KNPs on a lacey carbon substrate.

FIG. 11 shows KNP lateral size determination by atomic force microscopy (AFM). (panel a and b) Histogram of KNP lateral size and thickness with the associated statistics. (panel c and d) Example AFM micrograph with associated line profiles.

FIG. 12 shows full FTIR spectra (600-4000 cm⁻¹) of as-received bulk kaolinite and exfoliated KNP. Peak assignments are provided in Table 1.

FIG. 13 shows FTIR spectra of KNP-succinonitrile (SN) gel electrolytes focusing on the Si—O and Al—OH vibrational bands at ˜1025 cm⁻¹ and 909 cm⁻¹, respectively. As the relative content of the liquid electrolyte is increased, both vibrational bands are blue shifted, indicating an interaction with the electrolyte. Since the Si—O peak of KNP at ˜1000 cm⁻¹ overlaps with a peak from the liquid electrolyte, shift information cannot be extracted from this peak.

FIG. 14 shows Rheological properties of the KNP-SN gel electrolyte. Rheometry of the KNP(45%)-SN gel shows a storage modulus >10⁷ Pa with the storage modulus consistently greater than the loss modulus, indicating a quasi-solid nature. The rheometer was operated at 25° C. with a 8 mm parallel plate at 0.1% strain with a gap of 1 mm.

FIG. 15 shows ionic conductivity of the KNP-SN gels at various temperatures and KNP loadings. The dashed lines represent a Vogel-Fulcher-Tammann (VFT) model fit to σ=A exp[−B(T−T₀)]. The VFT fit parameters are provided in Table 3.

FIG. 16 shows chronoamperometry (CA) and electrochemical impedance spectroscopy (EIS) of a Li|Li cell allow the lithium transference number (Tu) of the SN liquid electrolyte (0.5 M LiTFSI+0.5 M LiBF₄+20 vol % FEC+SN) to be extracted.

FIG. 17 shows FTIR spectra of SN liquid electrolyte interactions as the relative concentration of KNP are varied in the KNP-SN gel electrolyte. FTIR spectra of various KNP-SN gel compositions in the range of: (panel a) the asymmetric stretch of −CF₃ within the TFSI anion at ˜1191 cm⁻¹ and the fluoroethylene carbonate (FEC) ring stretch at ˜ 1156 cm⁻¹; (panel b) the carbonyl stretching of FEC at ˜1830 cm⁻¹ and ˜ 1805 cm⁻¹; (panel c) the nitrile group stretching of SN at ˜2277 cm⁻¹ and ˜2254 cm⁻¹. When two peaks appear for the same functional group, a ratio (r) is calculated between the area of the larger peak to the smaller peak. The limits of integration are shown on each figure. In each case, as the loading of KNP increases, the ratio increases, indicating a change in the chemical environment of each species. The ratio of nitrile peaks in the KNP(65%)-SN gel could not be calculated due to the low intensity of the 2277 cm⁻¹ peak, which implies that an accurate integration could not be performed.

FIG. 18 shows FTIR spectra of succinonitrile liquid electrolyte components including: (panel a) LiBF₄; (panel b) LiTFSI; (panel c) succinonitrile; (panel d) fluoroethylene carbonate (FEC); (panel e) 1 M LiTFSI+SN; (panel f) 0.5 M LiTFSI+0.5 M LiBF₄+20 vol % FEC+SN.

FIG. 19 shows FTIR spectra of KNP-SN gel electrolytes at various loadings of KNP (KNP(X %)-SN): (panel a) 0.5 M LiTFSI+0.5 M LiBF₄+20 vol % FEC+SN (SN liquid electrolyte); (panel b) KNP; (panel c) KNP(25%)-SN; (panel d) KNP(45%)-SN; (panel e) KNP(65%)-SN.

FIG. 20 shows electrical conductivity test of the KNP-SN gel electrolyte. Chronoamperometry of SS|KNP(45%)-SN|SS with a bias of +2 V, until a steady-state current is reached.

FIG. 21 shows oxidative stability of the KNP-SN gel electrolyte. The plot shows chronoamperometry of a cell containing NCA|KNP(45%)-SN gel|Li, where the voltage is increased 0.1 V every 12 h. Beyond 4.5 V, the leakage current begins to increase, indicating oxidative stability of the electrolyte up to 4.5 V.

FIG. 22 shows stability of the KNP-SN gel electrolyte with lithium metal. Using a SS|KNP-SN Gel|Li cell configuration, the voltage was swept between-0.2 V and 3.0 V at 1 mV s⁻¹. The voltammogram shows stabilizing anodic and cathodic current over ten cycles related to lithium plating and stripping. No other peaks are present, indicating stability with lithium metal.

FIG. 23 shows Li|Li cycling stability of KNP-SN gel electrolyte at 0.2 mA cm⁻² with 1 h plate and 1 h strip cycles. (panel a) Stable cycling for over 400 h and (panel b) smaller data inset of the same cell.

FIG. 24 shows thermogravimetric analysis (TGA) profiles for annealed KNP powder, SN liquid-only electrolyte, and KNP(45%)-SN gel electrolyte in a nitrogen environment. Ramp rate is 10° C. min⁻¹ for all samples.

FIG. 25 shows discharge capacity comparison of NCA|KNP(45%)-SN Gel|Li and LFP| KNP(45%)-SN Gel|Li cells at room temperature and 60° C. Loading of the active material for all cells is >10 mg cm⁻².

FIG. 26 shows examples of cell conditioning prior to cycling stability testing. (panels a and b) Voltage-time curves for the LFP|Li cells, which used pulsed charging (15 s on, 90 s off) at a current density of 0.5 mA cm⁻² followed by a constant-current discharge also at the same current density. The first cycle included a charging capacity cutoff at 50% of the full charge, with the last cycle using a 4 V charging cutoff. (panel c) Voltage-time curves for the NCA|Li cells that underwent one CCCV cycle at 0.1 C followed by pulsed charging and then constant-current discharge with the same conditions as above.

### DETAILED DESCRIPTION OF THE INVENTION

The invention will now be described more fully hereinafter with reference to the accompanying drawings, in which exemplary embodiments of the invention are shown. However, this invention may be embodied in many different forms and should not be construed as limited to the embodiments set forth herein. Rather, these embodiments are provided so that this specification will be thorough and complete and fully convey the invention's scope to those skilled in the art. Like reference numerals refer to like elements throughout.

The terms used in this specification generally have their ordinary meanings in the art, within the context of the invention, and in the specific context where each term is used. Certain terms used to describe the invention are discussed below, or elsewhere in the specification, to provide additional guidance to the practitioner regarding the description. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, or section without departing from the invention's teachings.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures. is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. Therefore, the exemplary terms “below” or “beneath” can encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

Lithium-ion batteries are the leading energy storage technology for portable electronics and vehicle electrification. Traditional liquid electrolytes for lithium-ion batteries are highly flammable introducing a high risk of cell failure. Demands for enhanced energy density, safety, and scalability necessitate solid-state alternatives to traditional liquid electrolytes. Despite extensive research into less flammable solid-state electrolytes, few examples can be produced with earth abundant materials while concurrently providing sufficient performance metrics for commercial viability. Moreover, the rapidly increasing utilization of lithium-ion batteries further requires that next-generation electrolytes are derived from earth-abundant raw materials to minimize supply chain and environmental concerns.

Clay-based nanocomposite electrolytes hold significant promise since they utilize earth-abundant materials that possess superlative mechanical, thermal, and electrochemical stability, which suggests their compatibility with energy-dense lithium metal anodes. Despite these advantages, nanocomposite electrolytes rarely employ kaolinite, the most abundant variety of clay, due to strong interlayer interactions that have historically precluded efficient exfoliation of kaolinite nanoplatelets.

Other clay-based gel electrolytes have been demonstrated using other clays (e.g., halloysite or montmorillonite), which are generally easier to exfoliate, but are less earth abundant than kaolinite. Other electrolytes use a small amount of clay (<10 wt %) additives in polymer gel electrolytes, but these electrolytes typically use a volatile and flammable liquid electrolyte component.

Liquid-phase exfoliation of kaolinite has also been reported using sonication after pre-intercalation. However, this method is time consuming and thus has limited scalability. In addition, liquid-phase shear mixing has been attempted for kaolinite, but it required a significant excess of dispersion agent (5:1) that was not fully removed from the resulting nanomaterial.

To satisfy the increasing demand for higher energy densities, substantial effort has been devoted to utilizing lithium-ion battery anode and cathode materials with higher specific capacity. The lithium metal anode is foremost amongst potential electrode options with an order of magnitude higher specific capacity than incumbent graphite anodes. However, conventional liquid electrolytes are unstable against lithium metal anodes resulting in poor cycling efficiency and dendritic lithium growth that can lead to short circuits and catastrophic cell failure. Moreover, the high flammability of organic solvents poses serious safety concerns when short circuits occur due to resulting cell heating and subsequent combustible thermal runaway reactions. To overcome these issues, significant attention has been directed toward the development of solid-state electrolytes as a replacement for liquid electrolytes. Although considerable progress has been achieved, solid-state electrolytes based on inorganics and polymers continue to face important challenges in practical applications, including low ionic conductivity, high interfacial resistance, and/or poor manufacturability.

Nanocomposite gel electrolytes are ideally composed of a thermally stable nanomaterial matrix and chemically inert liquid electrolyte. In contrast to traditional battery electrolytes, nanocomposite gel electrolytes can be produced with materials that are significantly less flammable. Furthermore, the electrochemical stability window of the nanocomposite gel electrolyte can be tuned based on judicious choice of liquid electrolyte and additives, including stability against lithium metal anodes. Moreover, these electrolytes provide high ionic conductivity, favorable interfacial contact with electrodes, and wide processing compatibility, which address the key issues confronting inorganic and polymer solid-state electrolytes.

Material supply chains and cost are key concerns when considering components in lithium-ion batteries. Today, battery materials such as lithium, nickel, and cobalt are considered critical materials with challenging supply chains and volatile prices. Utilizing earth abundant materials such as kaolinite within the electrolyte help to keep the material cost down and prevent issues with supply chain sourcing due to geographic distribution. Moreover, other solid-state electrolytes such as Li₇La₃Zr₂O₁₂ use less abundant elements such as lanthanum and zirconium, whereas kaolinite consists primarily of silicon, aluminum, and oxygen, which are the three most abundant elements on earth. Furthermore, the liquid electrolyte component is succinonitrile, which is already mass produced and includes earth abundant carbon and nitrogen.

Exfoliation of kaolinite clay into nanoparticles or nanosheets is traditionally challenging given the strong interlayer attraction within the kaolinite structure. Traditional methods of exfoliation have required a chemical pretreatment, which can take up to 10 days and followed by energy intensive methods such as ball-milling to complete the process, which are either inefficient or limited in scalability.

In view of the above noted limitations, one of the objectives of this invention is to provides a method that utilizes a scalable liquid-phase exfoliation process to produce kaolinite nanoplatelets (KNPs) with high gravimetric surface area, thus enabling the formation of mechanically robust nanocomposites. The method involves the use of scalable liquid-phase shear mixing to exfoliate the kaolinite down to nanoplatelets. These kaolinite nanoplatelets have a high surface area per mass to immobilize the liquid electrolyte resulting in a mechanically robust gel electrolyte. The use of a nanocomposite gel electrolyte including kaolinite nanoplatelets resolves the flammable issues. Nanosized kaolinite made from a scalable shear mixing method results in a low-cost electrolyte with minimal supply chain concerns.

The KNPs are combined with succinonitrile (SN) liquid electrolytes to form a high-performance nanocomposite gel electrolyte with high room-temperature ionic conductivity (1 mS cm⁻¹), stiff storage modulus (>10 MPa), wide electrochemical stability window (4.5 V vs. Li/Li⁺), excellent thermal stability (>100° C.), and improved lithium-ion transference number (0.6 vs. 0.48 for SN alone). The resulting KNP-SN nanocomposite gel electrolyte is shown to be suitable for high-rate rechargeable lithium metal batteries that employ high-voltage LiNi_{0.8}Co_{0.15}Al_{0.05}O₂ (NCA) cathodes. While the primary focus here is on solid-state batteries, our strategy for kaolinite liquid-phase exfoliation can serve as a scalable manufacturing platform for a wide variety of other kaolinite-based nanocomposite applications.

The electrolyte is successfully applied in solid-state lithium metal batteries, demonstrating high-rate performance (maintaining 56% capacity at 2 mA cm⁻²), cycling stability (over 125 cycles at 0.5 mA cm⁻²), enhanced safety (non-flammable compared to conventional liquid electrolytes).

The invention, among other things, establishes a viable path for sustainable, high-performance solid-state lithium metal batteries, and provides advantages of scalability and sustainability—uses earth-abundant kaolinite, making it cost-effective and environmentally friendly, enhanced battery performance—supports lithium metal anodes, offering higher energy density than conventional libs, improved safety—eliminates flammable liquid electrolytes and enhances thermal stability, strong mechanical integrity—inhibits lithium dendrite formation, reducing the risk of short circuits, and versatility—beyond batteries, the exfoliation method can be applied to other kaolinite-based nanocomposite applications.

The invention may have widespread applications in solid-state batteries, lithium-ion batteries, supercapacitors, transistors, neuromorphic computing devices, flexible electronics, printed electronics, and the like.

Without intent to limit the scope of the invention, exemplary embodiments of the invention are given below.

One aspect of the invention relates to a method for scalable production of KNPs, comprising shear-mixing a mixture of bulk kaolinite with ethanol or water and a dispersing agent; centrifuging the shear-mixed mixture to sediment and remove unexfoliated bulk kaolinite, and obtain a supernatant containing the KNPs; flocculating the supernatant with deionized (DI) water or sodium chloride solution, collecting and drying flocculated KNPs; and annealing the flocculated KNPs to decompose and volatilize the remaining dispersing agent, thereby resulting in a partial coating of oxidized amorphous carbon on the surface of the KNPs.

In one embodiment, said flocculating the supernatant with deionized (DI) water is performed at a mass ratio of supernatant:DI water being about 1.5:1 to 1.75:1.

In one embodiment, said annealing the flocculated KNPs is performed in air at about 350-400° C. for 4 h.

In one embodiment, the dispersing agent is adapted to minimize re-agglomeration of the aluminosilicate layers.

In one embodiment, the dispersing agent comprises ethyl cellulose (EC), carboxymethyl cellulose (CMC), hydroxyethyl cellulose (HEC), hydroxypropyl methylcellulose (HPMC), hydroxypropyl cellulose (HPC), cellulose acetate (CA), or polyethylene glycol (PEG).

In one embodiment, yield of the KNPs from the bulk kaolinite after liquid phase exfoliation has an approximately linear relationship with a starting ratio of the EC to the bulk kaolinite.

In one embodiment, the starting ratio of the EC to the bulk kaolinite is less than about 0.5:1 (EC:kaolinite).

In one embodiment, the method further comprises recycling the sediment of unexfoliated bulk kaolinite, which generates an increase in yield of the KNPs about 20% compared to using fresh bulk kaolinite alone.

In one embodiment, the KNPs have a hexagonal plate-like morphology.

In one embodiment, the KNPs have an average lateral size and thickness of about 190±50 nm and about 17±5 nm, respectively.

In one embodiment, the distribution of the nanoplatelet thicknesses has a median thickness of about 3 nm with about 35% of the KNPs having a thickness less than about 2 nm.

In one embodiment, the XRD diffraction pattern for the KNPs shows a significantly diminished (001) reflection when compared to the (002) reflection, thereby verifying a significant disruption of the stacking periodicity of kaolinite layers following exfoliation.

In one embodiment, Fourier-transform infrared spectroscopy (FTIR) spectra of the KNPs have a blue shift in vibrational frequency in the hydroxyl and Si—O peaks compared to that of the bulk kaolinite.

In one embodiment, all peaks in the KNP spectrum can be mapped to the bulk kaolinite structure with the exception of a broad peak at 1440 cm⁻¹, which is attributed the C—O and C—H stretching from the annealed EC on the nanoplatelet surface.

In one embodiment, the KNPs have the Brunauer-Emmett-Teller (BET) surface area more than doubled from about 9.7 m² g⁻¹ to about 24 m² g⁻¹ following kaolinite exfoliation.

In one embodiment, the KNPs have excellent thermal stability with measurable mass loss only detectable at temperatures exceeding about 500° C.

In one embodiment, the KNPs have limited kaolinite nanoscroll morphology.

In one embodiment, the KNPs have high specific surface area relative to that of the bulk kaolinite, which facilitates strong gelation with liquid electrolytes at low mass loadings.

In one embodiment, the KNPs is dispersible with a liquid electrolyte to form a high-performance gel electrolyte.

Another aspect of the invention relates to kaolinite nanoplatelets (KNPs), produced according to the above method.

A further aspect of the invention relates to a nanocomposite gel electrolyte, comprising a succinonitrile-based (SN), dinitrile-based, ether-based, ethylene carbonate-based, propylene carbonate-based or ionic liquid-based liquid electrolyte; and kaolinite nanoplatelets (KNPs) mixed with the liquid electrolyte to form a KNP-SN gel electrolyte, denoted as KNP(x %)-SN, wherein x is a mass percentage of the KNPs in the KNP-SN gel electrolyte, wherein the KNPs are produced according to the method of claim 1.

In one embodiment, the KNP-SN gel electrolyte possesses a range of superlative properties including high room-temperature ionic conductivity (1 mS cm⁻¹), stiff storage modulus (>10 MPa), wide electrochemical stability window (4.5 V vs. Li/Li⁺), and excellent thermal stability (>100° C.).

In one embodiment, the liquid electrolyte comprises the electrolyte solvent mixed with lithium salts lithium bis(trifluoromethanesulfonyl)imide (LiTFSI), lithium tetrafluoroborate (LiBF₄)), lithium bis(fluorosulfonyl)imide (LiFSI), or lithium hexafluorophosphate (LiPF₆), along with a film-forming additive, fluoroethylene carbonate (FEC).

In one embodiment, FTIR spectra of the KNP-SN gel electrolyte have a blue shift of the interlayer hydroxyl group and Si—O vibrational bands as the relative SN content increases in the KNP-SN gel electrolyte.

The nanocomposite gel electrolyte of claim 21, being usable as both an electrolyte and a separator within LMB cells by preventing short-circuiting and inhibiting lithium dendrite growth. In one embodiment, the KNP-SN gel electrolyte has a quasi-solid nature that is confirmed by the storage modulus being consistently higher than the loss modulus across a wide range of shear frequencies.

In one embodiment, the KNP-SN gel electrolyte possesses a high ionic conductivity of 1 mS cm⁻¹ at 20° C.

In one embodiment, the lithium transference number (TLi) for the KNP-SN gel electrolyte is that 0.6.

In one embodiment, FTIR spectra of the KNP-SN gel electrolyte shows the blue shifting of the peaks associated with the asymmetric stretching of the —CF₃ groups within the TFSI anion and the carbonyl group of FEC as KNP content is increased, wherein the blue shifting is due to hydrogen bonding with exposed hydroxyl groups on the surface of the KNP.

In one embodiment, as the KNP loading increases, the relative area of the SN—Li⁺ peak decreases, indicating that lithium is being solvated by other species, likely the exposed silica surface of the KNPs.

In one embodiment, the combined effect of Li salt interactions with the KNP surface accounts for the increase in lithium transference number of the KNP-SN gel compared to the SN-only liquid electrolyte.

In one embodiment, the KNP-SN gel electrolyte has an electronic conductivity of about 6.30×10⁻¹⁰ S cm⁻¹, which is sufficiently insulating for solid-state electrolytes (SSEs) in energy storage applications.

In one embodiment, the KNP-SN gel reaches 2% mass loss at 100° C. (T_{2%}), which represents significantly higher thermal stability than traditional carbonate electrolytes.

In one embodiment, the KNP-SN gel is electrochemically stable with lithium metal over a range of potentials up to 4.5 V vs. Li/Li⁺.

In one embodiment, the KNP-SN gel electrolyte is compatible for energy-dense LMBs, the electrochemical stability window was evaluated at both high and low potentials relative to Li/Li⁺.

Yet a further aspect of the invention relates to an electrochemical device, comprising a positive electrode; a negative electrode; and a nanocomposite gel electrolyte disposed between the positive electrode and the negative electrode.

In one embodiment, the nanocomposite gel electrolyte is a KNP-SN gel electrolyte comprising a succinonitrile (SN) liquid electrolyte and kaolinite nanoplatelets (KNPs) mixed with the SN liquid electrolyte.

In one embodiment, the electrochemical device is a lithium metal battery (LMB).

In one embodiment, the positive electrode is an LiFePO₄ (LFP), Li₄TisO₁₂ (LTO), LiNi_{0.8}Co_{0.15}Al_{0.05}O₂ (NCA), LiNi_{0.33}Mn_{0.33}Co_{0.33}O₂ (NMC111), LiNi_{0.5}Mn_{0.3}Co_{0.2}O₂ (NMC532), LiNi_{0.6}Mn_{0.2}Co_{0.2}O₂ (NMC622), LiNi_{0.8}Mn_{0.1}Co_{0.1}O₂ (NMC811), LiNiO₂ (LNO), LiMn₂O₄ (LMO), or LiCoO₂ (LCO) positive electrode, and the negative electrode is a lithium metal electrode.

In one embodiment, when the positive electrode is with a high active material loading (>10 mg cm⁻²), both cell types achieve high discharge capacities of 160 mAh g⁻¹ and 200 mAh g⁻¹ at 0.1 C (0.18-0.2 mA cm⁻²) for LFP|Li and NCA|Li, respectively.

In one embodiment, the LMB has excellent rate capability and >56% capacity utilization compared to 0.1 C.

In one embodiment, the LMB has stable electrochemical operation.

In one embodiment, the LMB reaches 125 cycles with a capacity retention of 94% and 80% for LFP|Li and NCA|Li, respectively.

In one embodiment, the LMB has an improvement in rate of 12% and 22% for the LFP and NCA cells, respectively at 60° C.

The electrochemical device of claim 36, wherein the LMBs achieve excellent performance, particularly >56% capacity utilization up to a current density of 2 mA cm⁻².

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example

### Earth-Abundant Kaolinite Nanoplatelet Gel Electrolytes for Solid-State Lithium Metal Batteries

In this exemplary study, we report the fabrication of a gel electrolyte using kaolinite nanoplatelets (KNPs) produced via scalable liquid-phase exfoliation. The exfoliation process uses a low loading of ethyl cellulose (EC) dispersant (<0.5:1 EC:kaolinite) to achieve efficient extraction of KNPs from bulk kaolinite. The KNPs produced via this process exhibit high specific surface area relative to bulk kaolinite, which facilitates strong gelation with liquid electrolytes at low mass loadings. Specifically, when KNPs are mixed with a succinonitrile (SN) liquid electrolyte, the resulting gel electrolyte possesses a range of superlative properties including high room-temperature ionic conductivity (1 mS cm⁻¹), stiff storage modulus (>10 MPa), wide electrochemical stability window (4.5 V vs. Li/Li⁺), and excellent thermal stability (>100° C.). These desirable attributes are exploited in lithium metal batteries (LMB) using LiFePO₄ (LFP) or LiNi_{0.8}Co_{0.15}Al_{0.05}O₂ (NCA) positive electrodes paired with a thin (<50 μm) lithium metal electrode. These solid-state LMBs achieve excellent performance, particularly >56% capacity utilization up to a current density of 2 mA cm⁻². Furthermore, the cycling stability of these solid-state LMBs was tested using a charge/discharge current density of 0.5 mA cm⁻² with both LFP and NCA cell types producing lifetimes exceeding 125 cycles. Overall, this work establishes a scalable and sustainable approach for producing KNPs for solid-state LMBs and other kaolinite-based nanocomposite applications.

### Materials and Methods

Exfoliation of Kaolinite Clay: Bulk kaolinite (natural, Sigma-Aldrich) was exfoliated using liquid phase shear-mixing. The as-received bulk kaolinite (120 g) was mixed with ethanol (800 mL, 200 proof, Fischer Scientific) and various amounts of ethyl cellulose (EC) (12-60 g, 4 cP viscosity grade, Sigma-Aldrich) in a jacketed beaker with cooling water at 5° C. running through the jacket space. The mixture was shear-mixed at 10,230 rpm for 4 h (LMA-5, Silverson Machines) using a high-shear stator screen with square holes. The resulting mixture was then size-separated using a centrifuge (J-26 XPI, Beckman Coulter) at 4,000 rpm (rₘₐₓ=3,000 g) for 20 min. The supernatant containing the nanoplatelets was flocculated using deionized (DI) water at a 64:39 mass ratio (supernatant:DI water). The flocculated mixture was centrifuged at 7,500 rpm (rₘₐₓ=10,400 g) for 6 min after which the sediment was collected and dried at 120° C. for 4 h. The dried powder was annealed in air at 400° C. for 4 h to remove the remaining EC, resulting in a partial coating of oxidized amorphous carbon on the surface of the kaolinite nanoplatelets (KNPs).

Preparation of SN Liquid Electrolyte: Succinonitrile (SN) (Thermo-Fischer Scientific, 98%) was purified by solvent extraction in boiling diethyl ether. An insoluble and yellow-colored impurity remained after extraction and decanting. The extracted SN was then recrystallized in diethyl ether followed by drying under vacuum at 50° C. for 12 h. Purified SN was combined with 0.5 M LiBF₄, 0.5 M LiTFSI, and 20 vol % fluoroethylene carbonate (FEC), after which the mixture was magnetically stirred at 60° C. for 2 h and stored under an inert argon environment.

Characterization of KNP and KNP-SN Electrolyte Gel: Micrographs of bulk kaolinite (as-received), annealed KNP powder, and KNP-SN gel were taken using a scanning electron microscope (SEM) (SU8030, Hitachi). Powder samples were dispersed in isopropanol, bath sonicated, and drop casted onto a silicon wafer prior to imaging. Gel samples were manually deposited via a spatula onto carbon tape for imaging. FTIR (Nexus 870, Thermo-Nicolet) spectra of KNP, SN liquid electrolytes, and KNP gels were taken at various compositions using attenuated total reflectance (ATR) over the range of 600-4000 cm⁻¹ to determine the interactions between various components of the electrolyte. Atomic force microscopy (AFM) (Asylum Research Cypher, Oxford Instruments) was performed on the exfoliated KNPs to determine the lateral size and thickness of the nanoplatelets using the same powder sample preparation described above. Scanning transmission electron microscopy (S/TEM) (JEOL, ARM200) operating at 200 kV coupled with energy dispersive spectroscopy (EDS) (ThermoFisher, Dual SDD EDS (1.7sr)) was used to obtain TEM micrographs and EDS mapping. The powder samples were bath-sonicated in isopropanol solvent and drop casted on lacey carbon grid (300 mesh, Ted Pella) for this characterization. The convergent angle and collection angles for ADF-STEM imaging are 25 mrad and 90-250 mrad, respectively. Data acquisition and processing (background subtraction and principal component analysis for denoising and chemical mapping) was conducted using Gatan GMS software. X-ray photoelectron spectroscopy (XPS) (Thermo Scientific, ESCA Lab 250Xi XPS) was performed on the exfoliated KNPs. The spectrometer was equipped with a monochromated Al Kα X-ray source with 1486.6 eV energy. The XPS measurement spot size was ˜500 μm, and a flood gun was utilized for charge compensation. The XPS data analysis was performed using Avantage (Thermo Scientific) software where peaks were charge-corrected to adventitious carbon (C 1s) at 284.8 eV. X-ray diffraction (XRD) (Smartlab, 3 kW Gen2, Rigaku) was performed on both the bulk kaolinite and the annealed KNP. The θ-2θ XRD scans used a copper source (Kα=1.5406 Å) at a tube current and accelerating voltage of 35 mA and 40 kV, respectively. Nitrogen physisorption isotherms were performed on both the bulk kaolinite and the annealed KNPs, with 0.3 g of each sample dried at 120° C. under vacuum (VacPrep, Micrometrics) for >16 h until the rate of pressure change was below 0.001 mmHg/min prior to analysis. N₂ adsorption and desorption isotherms were then collected (3Flex, Micromeritics) at the normal boiling temperature of liquid nitrogen, and the surface area was calculated using the BET equation with embedded software (Micrometrics). The KNP-SN gel was produced by combining the KNP powder with SN liquid electrolyte in the desired mass ratio (i.e., KNP(x %)-SN) followed by mixing via mortar and pestle to produce the gel electrolyte. Rheology of the various KNP gels produced were measured using a rheometer (MCR 302, Anton Parr) at 25° C. with a parallel plate configuration (8 mm diameter), 1.0 mm gap, fixed 0.1% strain, and frequency sweep from 10⁻¹ to 10² rad s⁻¹. Thermogravimetric analysis (TGA/DSC 3+, Mettler-Toledo) was performed on KNP-EC mixtures, annealed KNP, SN liquid electrolyte, and KNP-SN gels using a nitrogen environment and a heating rate of 10° C. min⁻¹ from 25 to 800° C. A flame test was administered on both a KNP(45%)-SN gel and a traditional carbonate liquid electrolyte (1 M LiPF₆ in 1:1 EC:DEC (v/v)) by dosing 100 μg of either electrolyte onto a glass fiber separator (Whatman, GF/F, 2 cm diameter) and applying a propane torch flame to the sample for 1 s before being removing and observing the resulting reaction.

Electrode Preparation: The LFP and NCA positive electrodes were prepared using either LiFePO₄ (MTI, EQ-Lib-LFPO-S21) or LiNi_{0.8}Co_{0.15}Al_{0.05}O₂ (BASF TODA) along with carbon black (MTI, EQ-Lib-SuperC45), PVDF (MTI, EQ-Lib-PVDF), and purified SN mixed with LiTFSI at a molar ratio of 20:1 (SN:LiTFSI). The above components were mixed with NMP at ˜50 wt % at a ratio of 80:10:5:5 (active material:SN:CB:PVDF) to make a slurry that was blade-coated on carbon-coated aluminum foil (MTI, EQ-CC-Al-18u-260). The coated electrodes were initially dried at 80° C. for 30 min, followed by further drying under vacuum at 50° C. for 12 h. The dried electrodes were cut into 10 mm discs and calendared through a gap of 50-60 μm. Positive electrode discs used for rate testing contained an active material loading of 10-11 mg cm⁻², while those electrode discs used for cycle stability testing contained 5-6 mg cm⁻². The lithium metal negative electrodes (China Energy Lithium Co., >99.9%) were cut into 12.7 mm diameter discs and had a final thickness of <50 μm.

Electrochemical Characterization: Ionic conductivity (σ) of the KNP-SN gels was determined using electrochemical impedance spectroscopy (EIS) (VSP, BioLogic) with coin cells (CR2032) constructed with a stainless steel (SS)|KNP-SN|SS geometry. The ionic conductivity was determined according to the following equation,

$$σ = \frac{t}{R \times A} ,$$

where t and A are the thickness and cross-sectional area of the KNP-SN gel, respectively, and R is the bulk impedance as measured by EIS (10 mV amplitude, 1 MHZ-1 Hz). The temperature of the EIS coin cells was controlled by an environmental chamber (BTX-475, Espec). Lithium transference number (TLi) was measured by the Bruce-Vincent method. A coin cell with Li|Li symmetric structure was constructed, and a constant bias (ΔV) of 10 mV was applied for 2 h after which the current was recorded and an EIS measurement was performed before and after polarization. The lithium transference number was determined by the following equation,

$${T}_{Li} = \frac{{I}_{S} ( ΔV - {I}_{0} {R}_{0} )}{{I}_{0} ( ΔV - {I}_{S} {R}_{S} )} ,$$

where I_{S}/I₀ are the steady state and initial measured currents, and R_{S}/R₀ are the steady state and initial interfacial impedance as measured by EIS. Cyclic voltammetry (CV) was performed using a SS|KNP(45%)-SN gel|Li coin cell configuration where the SS electrode was swept between-0.2 V and 3.0 V at a rate of 1 mV s⁻¹ to probe the cathodic stability of the electrolyte. To determine the oxidative stability of the KNP-SN gel, chronoamperometry (CA) was performed using a NCA|KNP(45%)-SN gel|Li coin cell structure, where the cell was charged in 0.1 V increments with a voltage hold for 12 h while the leakage current was recorded. The cycling stability of lithium plating and stripping was measured using a Li|KNP(45%)-SN gel|Li coin cell with 1 hour plate/strip intervals at a current density of 0.2 mA cm⁻².

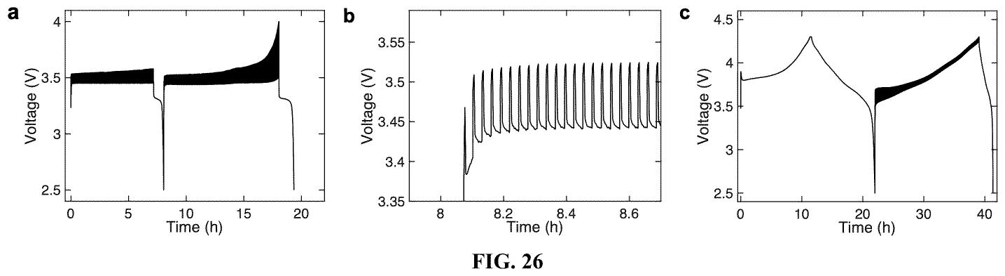

Battery Cell Cycling: KNP(45%)-SN gel was applied manually via a spatula and razor blade to the positive electrode discs (LFP or NCA). The final thickness of the gel was measured with a micrometer to be 200-300 μm. The coated positive electrode was combined with the lithium metal electrode and assembled into a CR2032 coin cell. All coin cell construction was performed inside an argon-filled glovebox. All galvanostatic cycling was performed using a battery cycling system (BT-2143, Arbin) at room temperature (22° C.) or elevated temperature (60° C.). LFP|Li cells were cycled between 2.5-4.0 V with 1 C=170 mA g⁻¹. NCA|Li cells were cycled between 2.5-4.3 V with 1 C=200 mA g⁻¹. Cells undergoing rate performance testing underwent no initial formation cycles. Cells undergoing cycling stability testing underwent two formation cycles. LFP|Li cells were conditioned using a pulsed charging method (0.5 mA cm⁻² charge, 15 s on/90 s off, 0.5 mA cm⁻² constant-current discharge) with a charge capacity limit for the first cycle (FIG. 26). NCA|Li cells underwent one CCCV cycle at 0.1 C charge/discharge with a voltage hold at 4.3 V followed by a second cycle using the same pulsed charging method.

### Results and Discussion

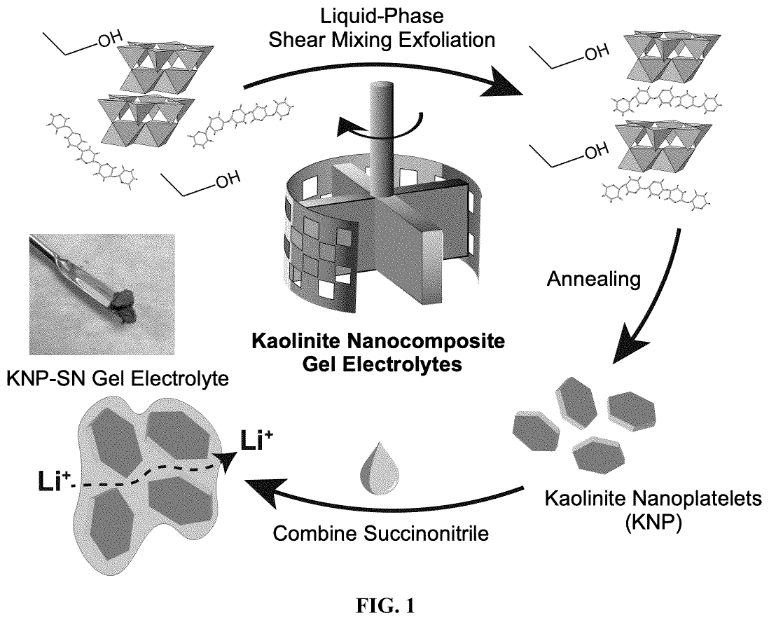

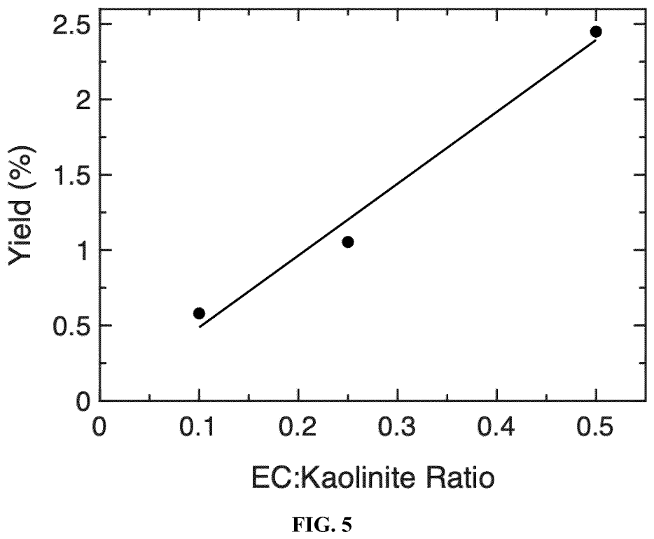

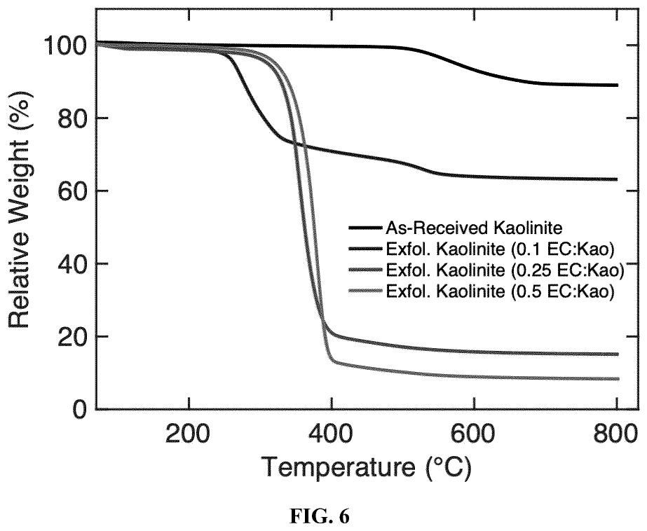

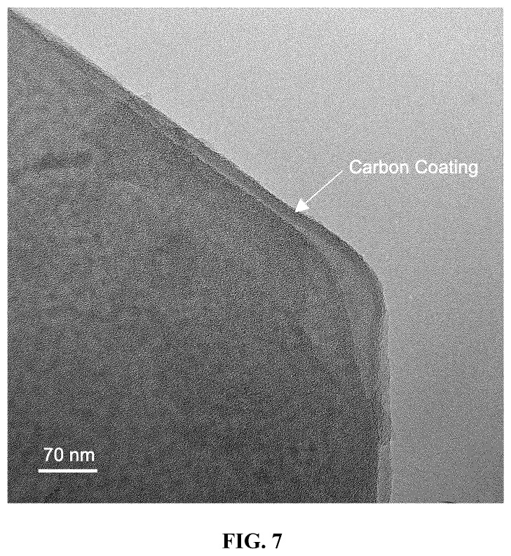

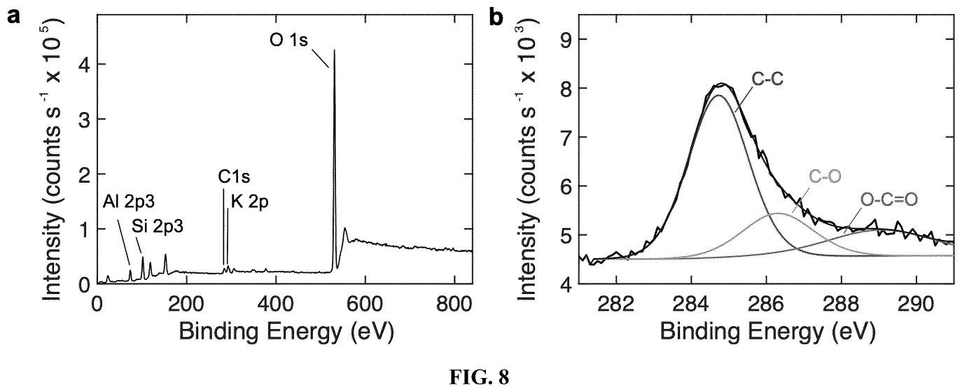

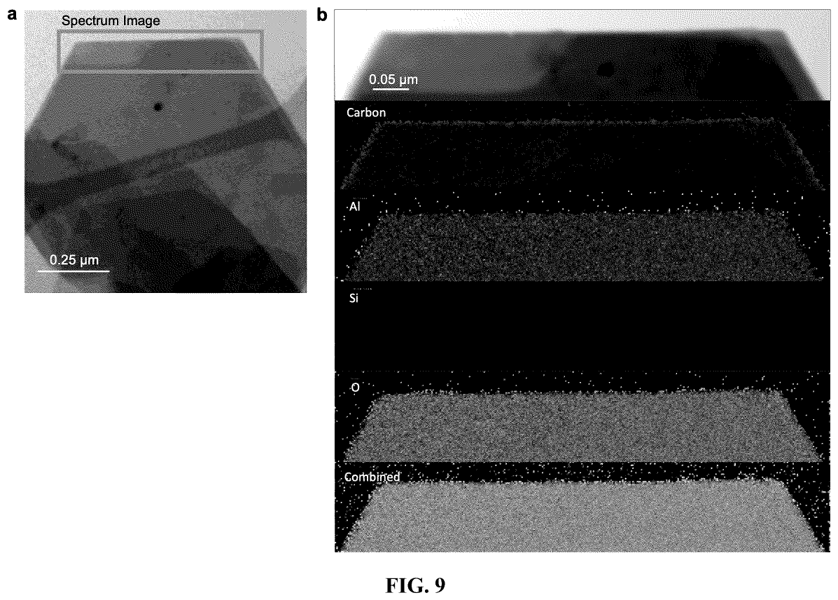

Liquid-Phase Exfoliation and Characterization of Kaolinite Nanoplatelets: FIG. 1 contains a schematic that depicts the preparation of KNP gel electrolytes from bulk kaolinite and liquid SN electrolyte. The exfoliation of bulk kaolinite to produce KNPs was executed using shear mixing in ethanol with EC added as a dispersing agent to minimize re-agglomeration of the aluminosilicate layers. The addition of EC to the shear-mixing suspension greatly improves the process yield with an approximately linear relationship observed between the KNP yield and the starting ratio of EC to bulk kaolinite (FIG. 5). After shear mixing, the dispersion is centrifuged to sediment and remove unexfoliated bulk kaolinite, which is then recovered for subsequent exfoliation. Recycling this sediment generates an increase in yield of ˜20% compared to using fresh bulk kaolinite alone even when accounting for residual EC in the sediment. The centrifugation supernatant that contains KNPs is flocculated with deionized water, collected, and dried. The flocculated KNP is then annealed to decompose and volatilize excess EC (FIG. 6), partially coating KNP in a non-conductive oxidized amorphous carbon coating, which gives the final powder a brownish color. The coating appears as a dark band along the KNP edges in transmission electron microscopy (TEM) (FIG. 7) and is further confirmed by X-ray photoelectron spectroscopy (XPS) (FIG. 8) as well as energy-dispersive X-ray spectroscopy (EDS) at the KNP edge (FIG. 9, panels a and b). Following the exfoliation and annealing steps, the resulting KNP powder can be readily dispersed with a liquid electrolyte such as SN to yield a high-performance gel electrolyte.

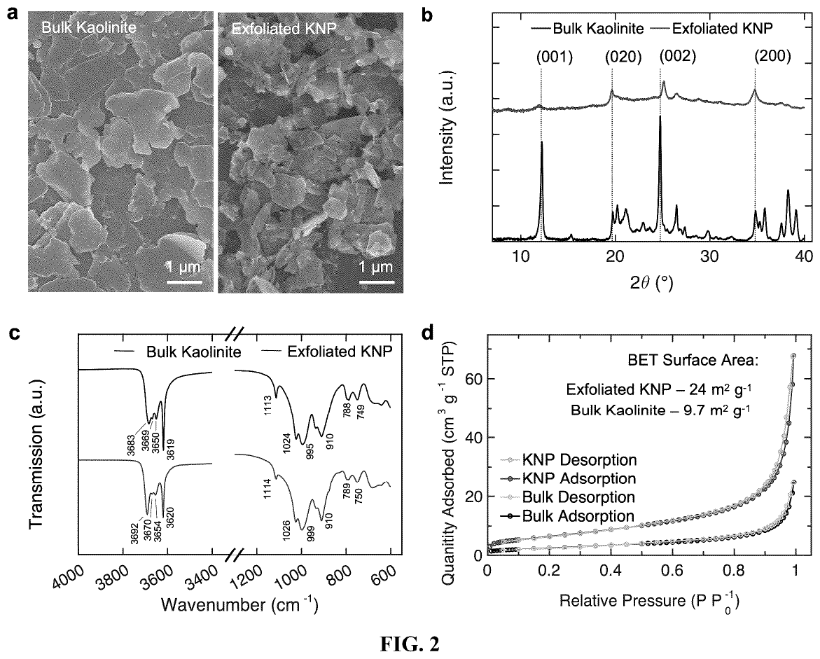

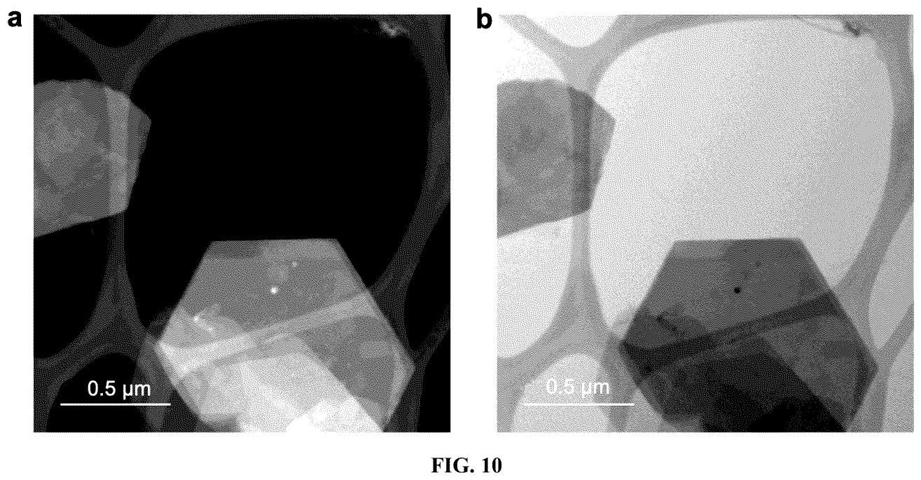

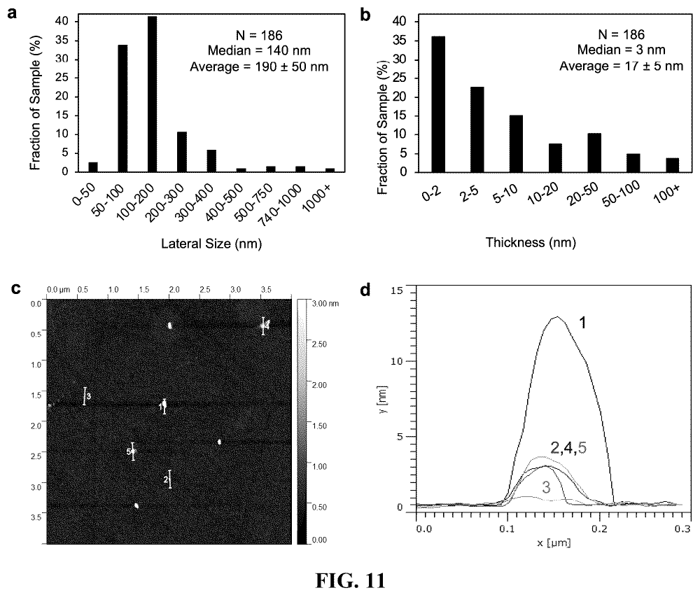

Characterization of the KNPs produced by EC-based liquid-phase exfoliation via scanning electron microscopy (SEM) (FIG. 2, panel a) and TEM (FIG. 10) shows a hexagonal plate-like morphology. Comparison of the SEM micrographs before and after exfoliation reveals a decrease in average lateral size that is then further quantified by atomic force microscopy (AFM) to reveal an average lateral size and thickness of 190±50 nm and 17±5 nm, respectively (FIG. 11). AFM also reveals that the distribution of nanoplatelet thicknesses has a median thickness of 3 nm with ˜35% of the KNPs having a thickness <2 nm, which is equivalent to ˜3 kaolinite layers (˜0.7 nm per layer). To validate this result, powder X-ray diffraction (XRD) was employed to study the KNP structure (FIG. 2, panel b). XRD of bulk kaolinite exhibits characteristic peaks at 2θ=12.24° (d₀₀₁=7.23 Å) and 2θ=24.74° (d₀₀₂=3.60 Å), corresponding to the basal planes of the silica tetrahedral and alumina octahedral sheets. In contrast, the XRD diffraction pattern for exfoliated KNPs shows a significantly diminished (001) reflection when compared to the (002) reflection, thereby verifying a significant disruption of the stacking periodicity of kaolinite layers following exfoliation.

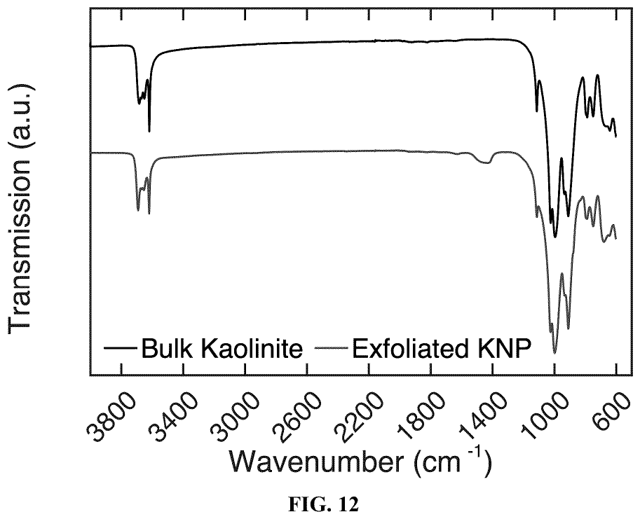

To ensure that the KNP exfoliation process does not degrade the kaolinite structure, FTIR was utilized (FIG. 2, panel c) with peak assignments being made according to reported spectral studies (FIG. 12, Table 1). The KNPs maintain the three characteristic hydroxyl peaks along the interlayer-surface (3692 cm⁻¹, 3670 cm⁻¹, and 3654 cm⁻¹) as well as the sharp peak at 3620 cm⁻¹ representing the inner hydroxyl stretching mode. Similarly, peaks at 1114 cm⁻¹, 1026 cm⁻¹, and 999 cm⁻¹ representing the Si—O vibrational modes are also present. It is notable that a blue shift in vibrational frequency is seen in the hydroxyl and Si—O peaks of the KNP spectra compared to bulk kaolinite, while the Al—OH band (910 cm⁻¹) remains consistent. This observation has been previously reported and attributed to the accumulation of structural defects in KNP along the Si—O and hydroxyl surfaces during exfoliation while the alumina octahedron remains mostly unaffected. All peaks in the KNP spectrum can be mapped to the bulk kaolinite structure with the exception of a broad peak at 1440 cm⁻¹, which can be attributed the C—O and C—H stretching from the annealed EC on the nanoplatelet surface.

TABLE 1
FTIR Peak Assignments for Bulk Kaolinite
and Exfoliated KNP from FIG. 12

| Vibration | Kaolinite (cm⁻¹) | KNP (cm⁻¹) |
|---|---|---|
| —OH, Surface | 3683 | 3692 |
| In-Phase Stretching | | |
| —OH, Surface, | 3669 | 3670 |
| Anti-Phase Stretching | 3650 | 3654 |
| —OH, Inner, Stretching | 3619 | 3620 |
| C—H, C—O, Stretching | 1440 (Broad) | — |
| Si—O, Symmetric Stretching | 1113 | 1114 |
| Si—O, Anti-Phase Stretching | 1024 | 1026 |
| | 995 | 999 |
| Al—OH, Surface, Bending | 934 | 936 |
| Al—OH, Inner, Bending | 910 | 910 |
| Si—O—Al, Translation | 788 | 789 |
| | 749 | 750 |

To further characterize the resulting KNPs, nitrogen adsorption isotherms were measured, revealing that the Brunauer-Emmett-Teller (BET) surface area more than doubled from 9.7 m² g⁻¹ to 24 m² g⁻¹ following kaolinite exfoliation (FIG. 2, d, Table 2). The lack of hysteresis in the nitrogen adsorption isotherms coupled with direct observations of the KNP morphology via SEM suggest the absence of kaolinite nanoscrolls unlike previously reported kaolinite exfoliation methods. This elimination of kaolinite nanoscrolls in our exfoliated samples can be attributed to the smaller lateral size of our KNPs, which suppresses rolling of the layers and results in higher gravimetric surface area than previous reports with extensive kaolinite nanoscrolls.

TABLE 2
BET Analysis of Bulk and Exfoliated
Kaolinite Particles from N₂ Isotherm

| | Bulk Kaolinite | Exfoliated Kaolinite |
|---|---|---|
| BET surface area (m²/g) | 9.72 ± 0.06 | 23.80 ± 0.07 |
| Slope (g/cm³ STP) | 0.4388 ± 0.003 | 0.18057 ± 0.0005 |
| Y-intercept (g/cm³ STP) | 0.0089 ± 0.0005 | 0.00229 ± 0.00009 |
| C (—) | 50.23 | 79.72 |
| Correlation coefficient (—) | 0.9998061 | 0.9999652 |

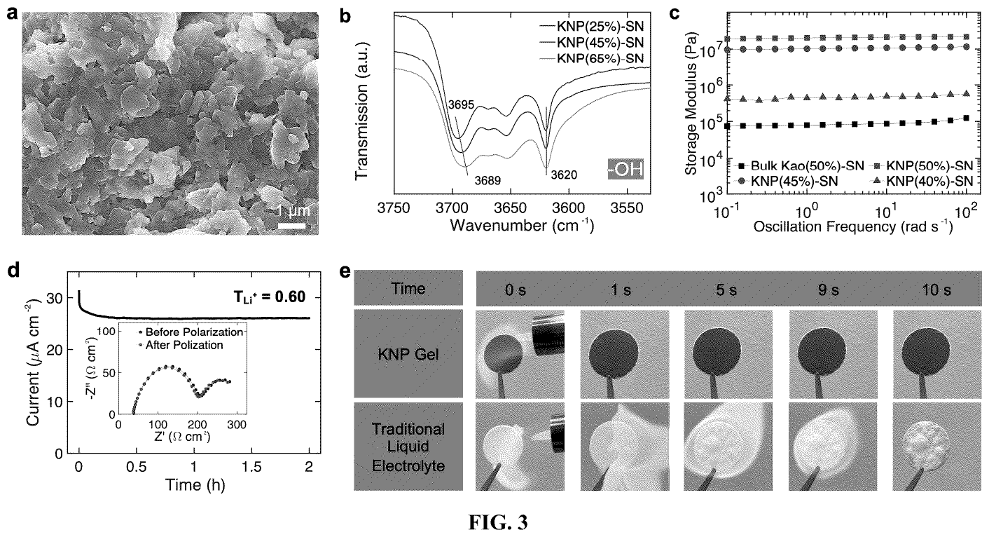

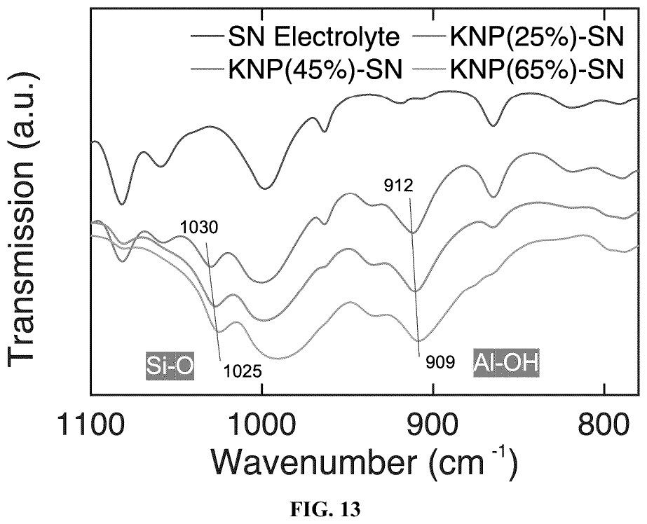

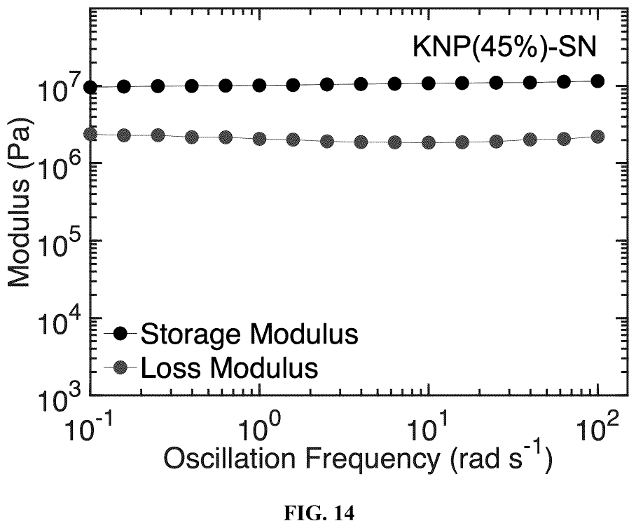

Characterization of Kaolinite Gel Electrolyte: To test the utility of the KNPs, they were mixed with a succinonitrile (SN) liquid electrolyte to produce a KNP-SN gel electrolyte denoted as KNP(x %)-SN, where x is the mass percent of KNP. SN has many advantages as an electrolyte including high thermal stability (T_{b}=266° C.), high ionic conductivity (>1 mS cm⁻¹), and high oxidative stability. Moreover, similar to kaolinite, SN is made from earth-abundant materials and is already mass-produced, facilitating its scalable use. To improve the stability of SN with lithium metal, SN was mixed with two lithium salts (lithium bis(trifluoromethanesulfonyl)imide (LiTFSI) and lithium tetrafluoroborate (LiBF₄)) along with a film-forming additive, fluorocthylene carbonate (FEC), similar to other reported SN electrolytes. FIG. 3, a shows an SEM micrograph of the resulting KNP-SN gel electrolyte, revealing the confinement of the liquid component along the contours of the nanoplatelets. The interaction between the KNP and liquid electrolyte phase is validated by FTIR as a blue shift of the interlayer hydroxyl group (FIG. 3, panel b) and Si—O (FIG. 13) vibrational bands as the relative SN content increases. As expected, the inner hydroxyl group peak at 3920 cm⁻¹ is unaffected by the electrolyte composition. These favorable interactions result in a high storage modulus (>10 MPa) of the KNP-SN gel, which enables its use as both an electrolyte and separator within LMB cells by preventing short-circuiting and inhibiting lithium dendrite growth (FIG. 3, panel c). In contrast, equivalent SN gel electrolytes made with bulk kaolinite showed a storage modulus that was over two orders of magnitude lower due to the lower surface area for interaction. The quasi-solid nature of the KNP-SN gel is further confirmed by the storage modulus being consistently higher than the loss modulus across a wide range of shear frequencies (FIG. 14).

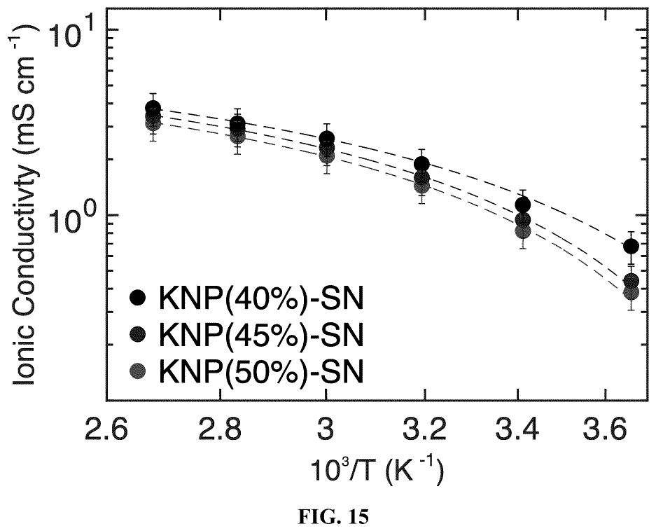

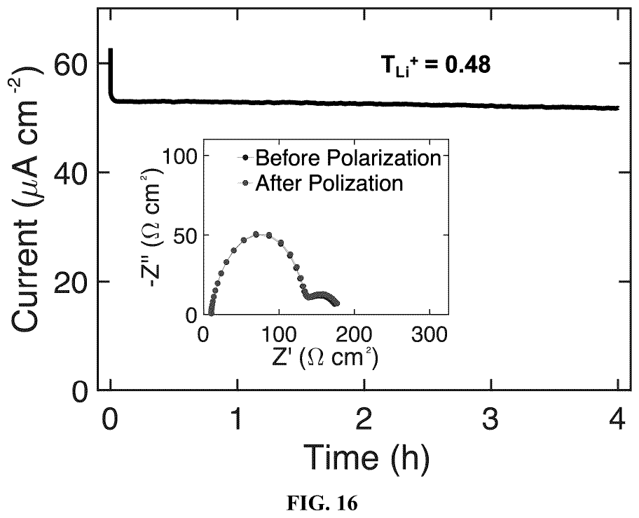

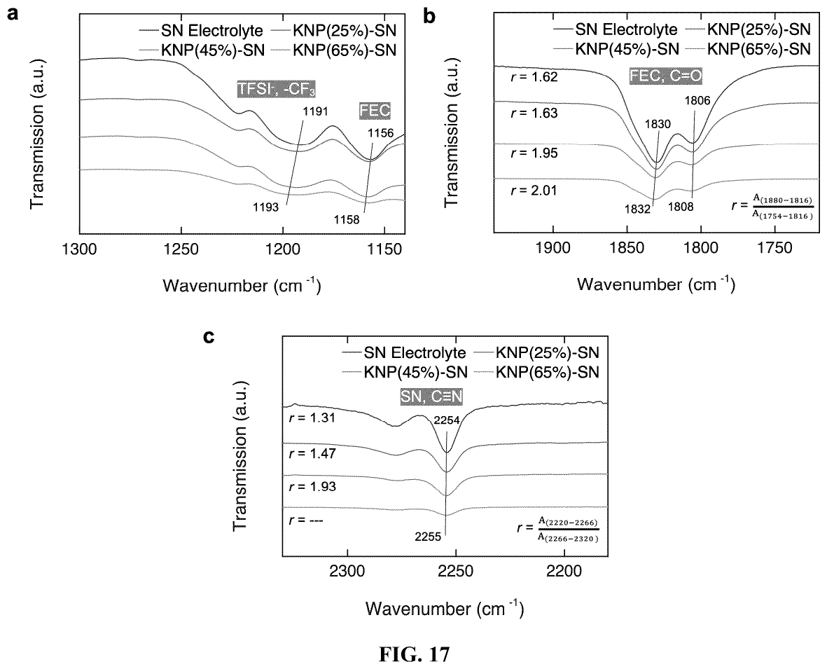

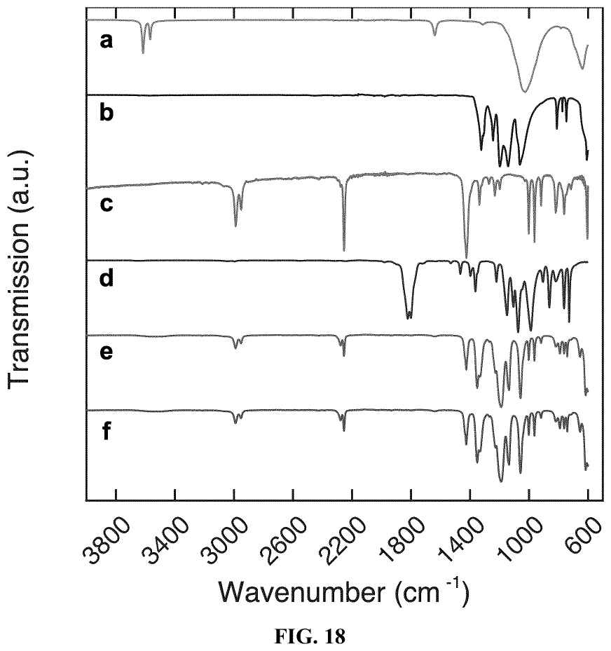

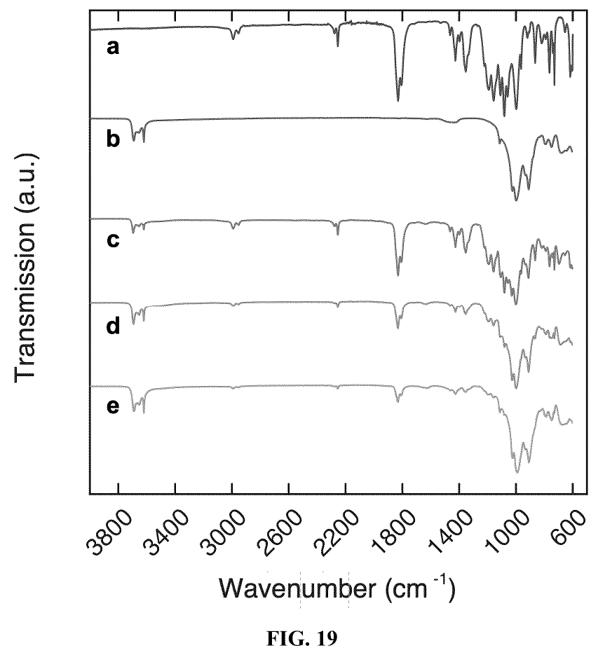

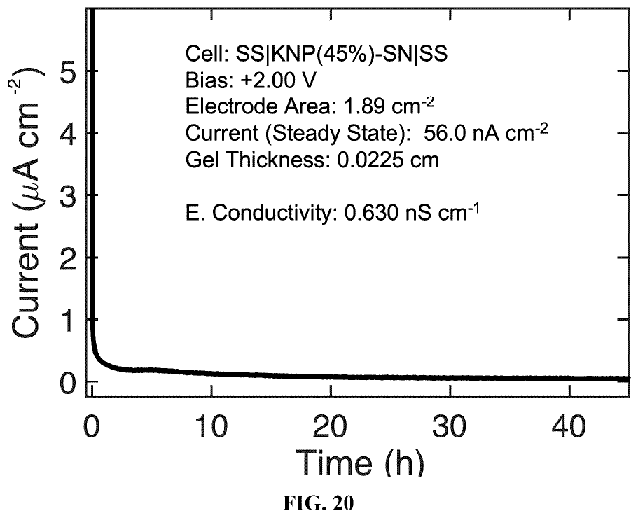

In addition to excellent mechanical properties, the KNP-SN gel possesses a high ionic conductivity of 1 mS cm⁻¹ at 20° C. (FIG. 15, Table 3), which is comparable to the SN component alone, enabling high-rate capability in LMB cells. Furthermore, FIG. 3, panel d shows that the lithium transference number (T_{Li}) extracted using the Bruce-Vincent method for the KNP-SN gel electrolyte is 0.6, which is higher than that measured for the SN liquid electrolyte alone (0.48, FIG. 16), displaying an additional advantage of the KNP-SN gel electrolyte. To investigate this point further, FTIR was employed to compare various KNP compositions in the electrolyte (FIG. 17). FIG. 17, panel a shows the blue shifting of the peak associated with the asymmetric stretching of the —CF₃ groups within the TFSI anion (˜1191 cm⁻¹) as KNP content is increased. This shift is likely due to hydrogen bonding with exposed hydroxyl groups on the surface of the KNP. A similar hydrogen bonding is also likely occurring with the carbonyl group of FEC as evidenced by a blue shift in the stretching peaks (˜1830 cm⁻¹ and ˜1806 cm⁻¹) accompanied with a change in relative intensity of the two modes (FIG. 17, panel b). Furthermore, FIG. 17, panel c shows nitrile stretching peaks (˜2254 cm⁻¹ and ˜2277 cm⁻¹), which previous studies have assigned to bulk SN and SN bound to the Li⁺ cation respectively. As the KNP loading increases, the relative area of the SN—Li⁺ peak decreases, indicating that lithium is being solvated by other species, likely the exposed silica surface of the KNPs, which has been demonstrated in other clay-based electrolytes. It appears likely that the combined effect of Li salt interactions with the KNP surface accounts for the increase in lithium transference number of the KNP-SN gel compared to the SN-only liquid electrolyte. It should be noted that an analysis of the BF₄ anion environment is obscured due to the overlap of the peak assigned to the BF₄ stretch at ˜1028 cm⁻¹ and the Si—O stretch of the KNPs (FIGS. 18-19). Additionally, regarding the partial coating of oxidized amorphous carbon on the KNPs, the low concentration and corresponding low spectral intensity preclude detailed FTIR analysis. Nevertheless, to eliminate concerns of electrical conductivity from the oxidized amorphous carbon on the KNPs, chronoamperometry (FIG. 20) was performed on the KNP-SN gel electrolyte, which revealed a measured conductivity was 6.30×10⁻¹⁰ S cm⁻¹, which is sufficiently insulating for SSEs in energy storage applications.

TABLE 3
Fit Parameters of Vogel-Fulcher-Tammann
Model for Ionic Conductivity

| | KNP(40%)- | KNP(45%)- | KNP(50%)- |
|---|---|---|---|
| σ = A exp[−B/(T − T₀)] | SN Gel | SN Gel | SN Gel |
| A (mS cm⁻¹) | 12.61 | 11.63 | 10.78 |
| B (K⁻¹) | 206.5 | 190.8 | 191.2 |
| T₀ (K) | 203.1 | 216.2 | 217.5 |

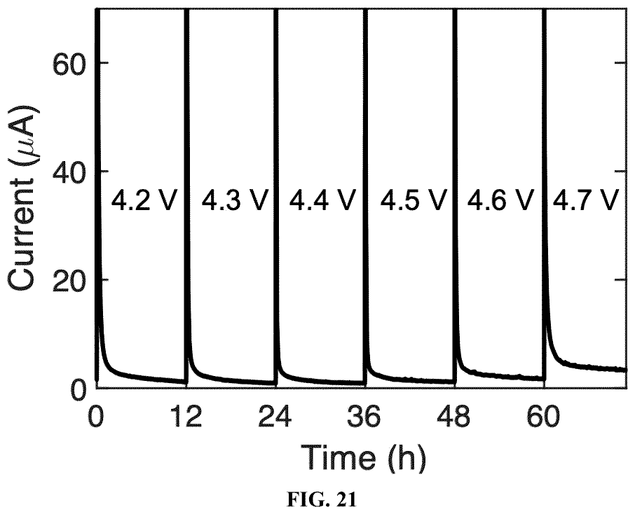

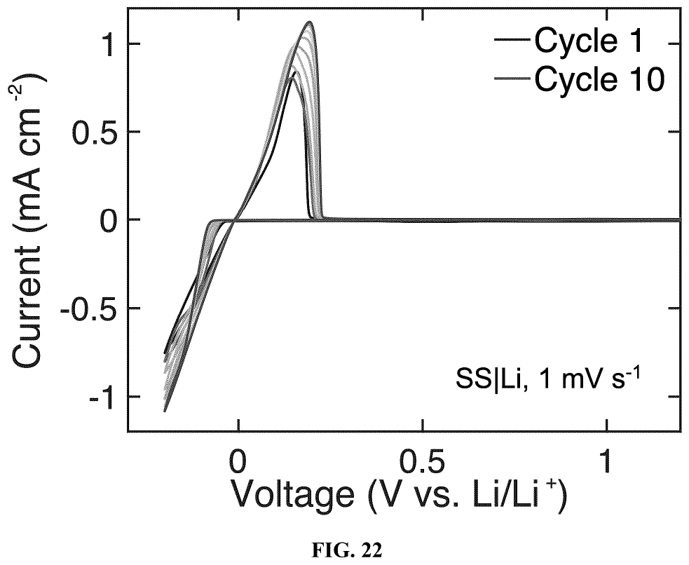

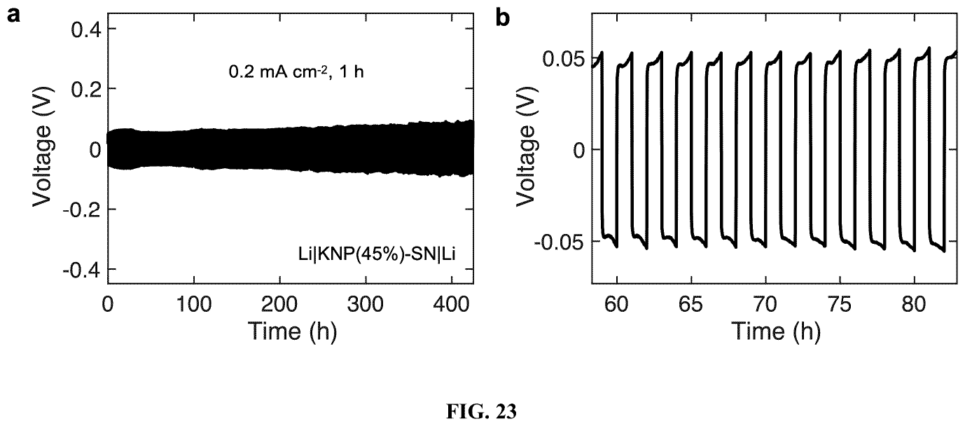

To further assess the compatibility of the KNP-SN gel electrolyte for energy-dense LMBs, the electrochemical stability window was evaluated at both high and low potentials relative to Li/Li⁺. Chronoamperometry (CA) was used to validate the oxidative electrochemical stability of the KNP-SN gel and its compatibility with high-voltage positive electrodes (FIG. 21). In particular, an NCA|KNP(45%)-SN|Li cell was charged in 0.1 V increments with 12 h voltage holds where the leakage current was measured at each step. Throughout this test, the leakage current remained low and did not increase step-over-step until 4.6 V vs. Li/Li⁺, which indicates the onset of deleterious side reactions from electrolyte breakdown. Thus, the oxidative stability limit of the KNP-SN gel is at least 4.5 V vs. Li/Li⁺, which is sufficient for many high-voltage and energy-dense positive electrodes. To test the stability with a lithium metal negative electrode, cyclic voltammetry (CV) was executed between −0.2 V and 3.0 V using a stainless steel (SS) blocking electrode paired with Li metal (FIG. 22). The voltammogram shows the cell approaching apparent stability after seven cycles with the anodic and cathodic current increasing but remaining roughly equal in magnitude until this point. After the seventh cycle, the peak currents and overpotentials stabilize, indicating that surface layers have been sufficiently formed to inhibit further reaction. To further validate this stability, Li|KNP(45%)-SN|Li symmetric cells were constructed and cycled at 0.2 mA cm⁻² with 1 h charge/discharge times, revealing stable operation for over 400 h as shown in FIG. 23.

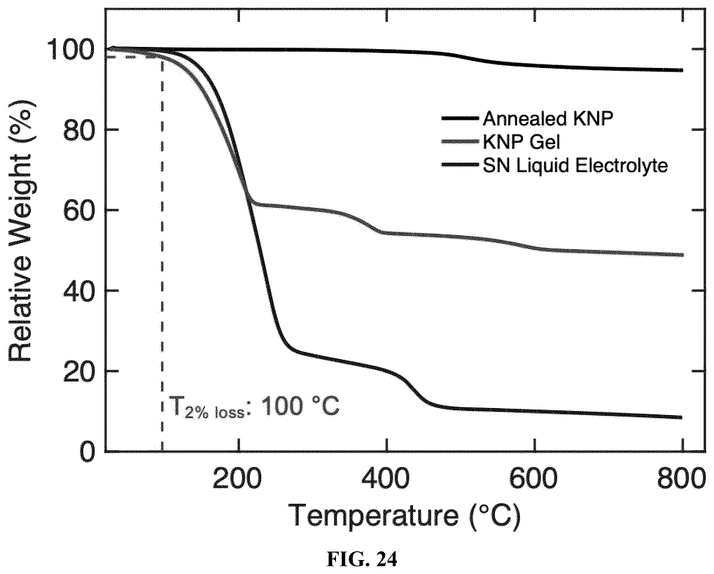

Since thermal stability and safety are key factors for LMB electrolytes, the thermal stability of the KNP-SN gel and its components were measured using thermogravimetric analysis (TGA) (FIG. 24). The annealed KNP powder has excellent thermal stability with measurable mass loss only detectable at temperatures exceeding ˜500° C., where it is known that dehydroxylation of the kaolinite structure occurs. The KNP-SN gel reaches 2% mass loss at 100° C. (T_{2%}), which represents significantly higher thermal stability than traditional carbonate electrolytes. To validate this result, FIG. 3, panel e shows flame test results comparing the flammability of the KNP-SN gel electrode compared to a traditional carbonate liquid electrolyte (1 M LiPF₆ in 1:1 EC:DEC (v/v)). The same mass of each electrolyte was supported on separate glass fiber separators, after which a torch was applied to the sample for the same length of time. In the case of the KNP-SN gel, the sample was not ignited, whereas the carbonate electrolyte caught fire and burned until the electrolyte was fully consumed. The higher thermal stability of KNP-SN gels compared to traditional liquid electrolytes implies enhanced safety in LMB applications.

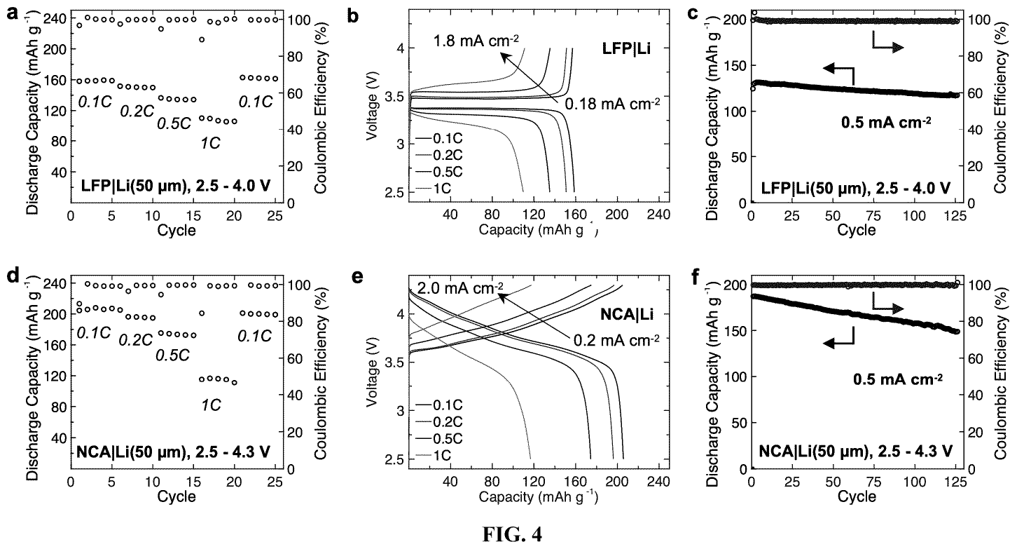

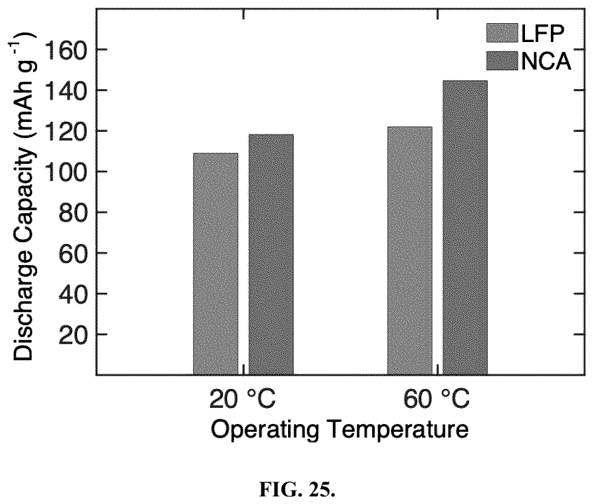

Lithium Metal Battery Performance with Kaolinite Gel Electrolyte: To test the LMB rate performance and cycling stability of the KNP-SN gel electrolyte, LFP|Li and NCA|Li cells were constructed using the KNP(45%)-SN gel as both the electrolyte and separator. FIG. 4, panels a and d show the rate performance of these different cells. Using positive electrodes with high active material loading (>10 mg cm⁻²), both cell types achieved high discharge capacities of 160 mAh g⁻¹ and 200 mAh g⁻¹ at 0.1 C (0.18-0.2 mA cm⁻²) for LFP|Li and NCA|Li, respectively. Furthermore, the cells maintained a discharge capacity of at least 115 mAh g⁻¹ at a 1 C rate (1.8-2.0 mA cm⁻²), exhibiting excellent rate capability and >56% capacity utilization compared to 0.1 C. The voltage profiles of both cell types (FIG. 4, panels b and e) appear as expected, with flat plateaus near ˜3.48 V and ˜3.37 V for LFP|Li cells and a slope in voltage for NCA|Li cells, indicating stable electrochemical operation. The cycle stability of the LFP|Li and NCA|Li cells (FIG. 4, panels c and f) were tested with thin lithium metal (50 μm) at a charge/discharge current density of 0.5 mA cm⁻², which is comparable to or higher than reported stability testing of other SN electrolytes. The positive electrode active material loading for cycle stability testing was chosen to be 5 mg cm⁻² to expedite the testing time. Both cell types reached 125 cycles with a capacity retention of 94% and 80% for LFP|Li and NCA|Li, respectively, which is comparable to the performance of recently reported cycle stability testing of SN electrolytes (Table 4). Given the high thermal stability of the KNP-SN gel electrolyte, the rate capability at 1 C of both LFP|Li and NCA|Li cells was tested at 60° C. (FIG. 25). Both cell types showed an improvement in rate of 12% and 22% for the LFP and NCA cells, respectively, displaying an additional advantage of the high thermal stability of the KNP-SN gel electrolyte. By combining state-of-the-art LMB cycling and rate performance metrics with enhanced thermal stability, safety, and earth-abundant raw materials, the KNP-SN gel electrolyte is a promising option for next-generation energy storage technologies.

TABLE 4
Cycle Stability Testing Performance for Recently Reported SN-Based Electrolytes

| | Positive/Negative | Current | | Cycles | |
|---|---|---|---|---|---|
| | (Active Material | Density | | Completed | |
| Electrolyte | Loading (mg cm⁻²)) | (mA cm⁻²) | | (—) | Ref. |
| KNP-SN gel | NCA (5)/Li (50 μm) | 0.5 | (RT) | 125 | This Work |
| KNP-SN gel | LFP (5)/Li (50 μm) | 0.5 | (RT) | 125 | This Work |
| SN:LiTFSI:LiDFOB | LCO (2)/Li | 0.14 | (RT) | 100 | [45] |
| (20:0.6:0.4 molar) + | | | | | |
| 10% FEC | | | | | |
| 1M LiBF4 in SN + | NMC-532 (2.5)/ | 0.225 | (RT) | 100 | [46] |
| 20 wt % FEC | Li (450 μm) | | | | |
| 4 mol % LiBOB | LFP (5)/Li | 0.07 | (40° C.) | 200 | [52] |
| in SN | | | | | |
| 4 mol % LiBOB | NMC-532 (5)/Li | 0.05 | (40° C.) | 20 | [52] |
| in SN | | | | | |
| GPE-SN | LCO (2)/Li | 0.055 | (RT) | 100 | [53] |
| (poly(urethane | | | | | |
| acetate)-SN) | | | | | |
| PIL-SN | LFP (2.5)/Li | 0.2125 | (RT) | 50 | [54] |
| LLTO-PAN-SN | LFP(2.5)/Li | 0.213 | (30° C.) | 150 | [55] |
| MOF-SN-FEC | LFP (2.5)/Li | 0.043 | (RT) | 100 | [56] |
| PCEE | NMC-83 (10)/ | 0.1-0.5 | (30° C.) | 100 | [57] |

| | |
|---|---|
| (poly(butylacrylate)- | Li (35 μm) |
| SN) | |

### CONCLUSION

In conclusion, we have developed a scalable method of kaolinite exfoliation to produce KNPs that can be combined with SN to create a high modulus and thermally stable gel electrolyte for use in solid-state LMBs. The exfoliation of bulk kaolinite is achieved with liquid-phase shear mixing using ethanol/EC to produce nanoplatelets based on the most earth-abundant clay. The resulting KNP-SN gel electrolyte achieves a range of superlative properties including high room-temperature ionic conductivity (>1 mS cm⁻¹), stiff storage modulus (>10 MPa), and excellent thermal stability (>100° C.). Additionally, the interaction of the electrolyte with the exposed KNP surface results in an increase of the lithium-ion transference number compared to the liquid electrolyte alone (T_{Li}=0.6 versus 0.48). Furthermore, the KNP-SN gel is electrochemically stable with lithium metal over a range of potentials up to 4.5 V vs. Li/Li⁺. This electrochemical stability was utilized in LMB cells with both LFP and NCA positive electrodes against thin (50 μm) lithium metal negative electrodes. The rate capability of the LMB cells was tested using thick (>10 mg cm⁻² active material) positive electrodes, with both cell types achieving >56% capacity utilization up to a current density of 2 mA cm⁻². Additionally, the cycle stability of the LMB cells was tested using a charge/discharge current density of 0.5 mA cm⁻² with both cell types achieving >125 cycles, which is comparable to other state-of-the-art SN electrolytes. Overall, this work provides a viable path for the scalable exfoliation of kaolinite clay into KNPs that are suitable for solid-state LMBs in addition to other clay nanocomposite applications.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described to explain the principles of the invention and their practical application to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. Manthiram, A. An outlook on lithium ion battery technology. ACS Cent. Sci. 2017, 3 (10), 1063-1069. DOI: 10.1021/acscentsci.7b00288
[2]. Chu, S.; Cui, Y.; Liu, N. The path towards sustainable energy. Nat. Mater. 2017, 16 (1), 16-22. DOI: 10.1038/nmat4834
[3]. Liu, K.; Liu, Y.; Lin, D.; Pei, A.; Cui, Y. Materials for lithium-ion battery safety. Sci. Adv. 2018, 4 (6), caas9820. DOI: 10.1126/sciadv.aas9820
[4]. Manthiram, A.; Yu, X.; Wang, S. Lithium battery chemistries enabled by solid-state electrolytes. Nat. Rev. Mater. 2017, 2 (4), 16103. DOI: 10.1038/natrevmats.2016.103
[5]. Zheng, F.; Kotobuki, M.; Song, S.; Lai, M. O.; Lu, L. Review on solid electrolytes for all-solid-state lithium-ion batteries. J. Power Sources 2018, 389, 198-213. DOI: 10.1016/j.jpowsour.2018.04.022
[6]. Wang, Q.; Mao, B.; Stoliarov, S. I.; Sun, J. A review of lithium ion battery failure mechanisms and fire prevention strategies. Prog. Energy Combust. Sci. 2019, 73, 95-131. DOI: 10.1016/j.pecs.2019.03.002
[7] Betz, J.; Bicker, G.; Meister, P.; Placke, T.; Winter, M.; Schmuch, R. Theoretical versus practical energy: A plea for more transparency in the energy calculation of different rechargeable battery systems. Adv. Energy Mater. 2019, 9 (6), 1803170. DOI: 10.1002/aenm.201803170
[8]. Randau, S.; Weber, D. A.; Kötz, O.; Koerver, R.; Braun, P.; Weber, A.; Ivers-Tiffée, E.; Adermann, T.; Kulisch, J.; Zeier, W. G.; Richter, F. H.; Janek, J. Benchmarking the performance of all-solid-state lithium batteries. Nat. Energy 2020, 5 (3), 259-270. DOI: 10.1038/s41560-020-0565-1
[9]. Tan, D. H. S.; Banerjee, A.; Chen, Z.; Meng, Y. S. From nanoscale interface characterization to sustainable energy storage using all-solid-state batteries. Nat. Nanotechnol. 2020, 15 (3), 170-180. DOI: 10.1038/s41565-020-0657-x
[10]. Xu, L.; Lu, Y.; Zhao, C.-Z.; Yuan, H.; Zhu, G.-L.; Hou, L.-P.; Zhang, Q.; Huang, J.-Q. Toward the scale-up of solid-state lithium metal batteries: The gaps between lab-level cells and practical large-format batteries. Adv. Energy Mater. 2021, 11 (4), 2002360. DOI: 10.1002/aenm.202002360
[11]. Huang, K. J.; Ceder, G.; Olivetti, E. A. Manufacturing scalability implications of materials choice in inorganic solid-state batteries. Joule 2021, 5 (3), 564-580. DOI: 10.1016/j.joule.2020.12.001
[12]. Duffner, F.; Kronemeyer, N.; Tubke, J.; Leker, J.; Winter, M.; Schmuch, R. Post-lithium-ion battery cell production and its compatibility with lithium-ion cell production infrastructure. Nat. Energy 2021, 6 (2), 123-134. DOI: 10.1038/s41560-020-00748-8
[13]. Lan, Y.; Liu, Y.; Li, J.; Chen, D.; He, G.; Parkin, I. P. Natural clay-based materials for energy storage and conversion applications. Adv. Sci. 2021, 8 (11), 2004036. DOI: 10.1002/advs.202004036
[14]. Dedzo, G. K.; Detellier, C. Clay minerals—ionic liquids, nanoarchitectures, and applications. Adv. Funct. Mater. 2018, 28 (27), 1703845. DOI: 10.1002/adfm.201703845
[15]. Wypych, F.; de Freitas, R. A. Chapter 1-Clay minerals: Classification, structure, and properties. In Developments in Clay Science, Vol. 10; Elsevier, 2022; pp 3-35. DOI: 10.1016/B978-0-323-91858-9.00004-5
[16]. Chua, S.; Fang, R.; Sun, Z.; Wu, M.; Gu, Z.; Wang, Y.; Hart, J. N.; Sharma, N.; Li, F.; Wang, D.-W. Hybrid solid polymer electrolytes with two-dimensional inorganic nanofillers. Chem. Eur. J. 2018, 24 (69), 18180-18203. DOI: 10.1002/chem.201804781
[17]. Zhu, Q.; Wang, X.; Miller, J. D. Advanced nanoclay-based nanocomposite solid polymer electrolyte for lithium iron phosphate batteries. ACS Appl. Mater. Interfaces 2019, 11 (9), 8954-8960. DOI: 10.1021/acsami.8b13735
[18]. Feng, J.; Ao, X.; Lei, Z.; Wang, J.; Deng, Y.; Wang, C. Hollow nanotubular clay composited comb-like methoxy poly(ethylene glycol) acrylate polymer as solid polymer electrolyte for lithium metal batteries. Electrochim. Acta 2020, 340, 135995. DOI: 10.1016/j.electacta.2020.135995
[19]. Lin, Y.; Wang, X.; Liu, J.; Miller, J. D. Natural halloysite nano-clay electrolyte for advanced all-solid-state lithium-sulfur batteries. Nano Energy 2017, 31, 478-485. DOI: 10.1016/j.nanoen.2016.11.045
[20]. Tang, W.; Tang, S.; Zhang, C.; Ma, Q.; Xiang, Q.; Yang, Y.-W.; Luo, J. Simultaneously enhancing the thermal stability, mechanical modulus, and
electrochemical performance of solid polymer electrolytes by incorporating 2D sheets. Adv. Energy Mater. 2018, 8 (24), 1800866. DOI: 10.1002/aenm.201800866
[21]. Zhang, Y.; Zhao, Y.; Gosselink, D.; Chen, P. Synthesis of poly(ethylene-oxide)/nanoclay solid polymer electrolyte for all solid-state lithium/sulfur battery. Ionics 2015, 21 (2), 381-385. DOI: 10.1007/s11581-014-1176-2
[22]. Zhu, M.; Lan, J.; Tan, C.; Sui, G.; Yang, X. Degradable cellulose acetate/poly-1-lactic acid/halloysite nanotube composite nanofiber membranes with outstanding performance for gel polymer electrolytes. J. Mater. Chem. A 2016, 4 (31), 12136-12143. DOI: 10.1039/C6TA05207J
[23]. Jcon, Y. M.; Kim, S.; Lec, M.; Lec, W. B.; Park, J. H. Polymer-clay nanocomposite solid-state electrolyte with selective cation transport boosting and retarded lithium dendrite formation. Adv. Energy Mater. 2020, 10 (47), 2003114. DOI: 10.1002/aenm.202003114
[24]. Deka, M.; Kumar, A. Electrical and electrochemical studies of poly(vinylidene fluoride)-clay nanocomposite gel polymer electrolytes for Li-ion batteries. J. Power Sources 2011, 196 (3), 1358-1364. DOI: 10.1016/j.jpowsour.2010.09.035
[25]. Shubha, N.; Prasanth, R.; Hoon, H. H.; Srinivasan, M. Dual phase polymer gel electrolyte based on non-woven poly(vinylidenefluoride-co-hexafluoropropylene)-layered clay nanocomposite fibrous membranes for lithium ion batteries. Mater. Res. Bull. 2013, 48 (2), 526-537. DOI: 10.1016/j.materresbull.2012.11.002
[26]. Hwang, J. J.; Liu, H. J. Influence of organophilic clay on the morphology, plasticizer-maintaining ability, dimensional stability, and electrochemical properties of gel polyacrylonitrile (PAN) nanocomposite electrolytes. Macromolecules 2002, 35 (19), 7314-7319. DOI: 10.1021/ma020613r
[27]. Prasanth, R.; Shubha, N.; Hng, H. H.; Srinivasan, M. Effect of nano-clay on ionic conductivity and electrochemical properties of poly(vinylidene fluoride) based nanocomposite porous polymer membranes and their application as polymer electrolyte in lithium ion batteries. Eur. Polym. J. 2013, 49 (2), 307-318. DOI: 10.1016/j.curpolymj.2012.10.033
[28]. Grishina, E. P.; Ramenskaya, L. M.; Kudryakova, N. O.; Vagin, K. V.; Kracv, A. S.; Agafonov, A. V. Composite nanomaterials based on 1-butyl-3-methylimidazolium dicianamide and clays. J. Mater. Res. Technol. 2019, 8 (5), 4387-4398. DOI: 10.1016/j.jmrt.2019.07.050
[29]. Zhao, N.; Liu, Y.; Zhao, X.; Song, H. Liquid crystal self-assembly of halloysite nanotubes in ionic liquids: a novel soft nanocomposite ionogel electrolyte with high anisotropic ionic conductivity and thermal stability. Nanoscale 2016, 8 (3), 1545-1554. DOI: 10.1039/C5NR06888F
[30]. Noskov, A. V.; Alekseeva, O. V.; Shibaeva, V. D.; Agafonov, A. V. Synthesis, structure and thermal properties of montmorillonite/ionic liquid ionogels. RSC Adv. 2020, 10 (57), 34885-34894. DOI: 10.1039/DORA06443B
[31]. Aleksceva, O. V.; Shibacva, V. D.; Noskov, A. V.; Ivanov, V. K.; Agafonov, A. V. Enhancing the thermal stability of ionogels: Synthesis and properties of triple ionic liquid/halloysite/MCC ionogels. Molecules 2021, 26 (20), 6198. DOI: 10.3390/molecules26206198
[32]. Mao, H.; Ding, Z. Electrolytes based on nano-2D interlayer structure of Al-pillared clays for solid-state lithium battery. J. Mater. Sci.: Mater. Electron. 2020, 31 (16), 13874-13888. DOI: 10.1007/s10854-020-03947-x
[33]. Kalaga, K.; Rodrigues, M.-T. F.; Gullapalli, H.; Babu, G.; Arava, L. M. R.; Ajayan, P. M. Quasi-solid electrolytes for high temperature lithium ion batteries. ACS Appl. Mater. Interfaces 2015, 7 (46), 25777-25783. DOI: 10.1021/acsami.5b07636
[34]. U.S. Geological Survey. Mineral Commodity Summaries 2023; https://doi.org/10.3133/mcs2023 (accessed 2023 Feb. 1)
[35]. Kuroda, Y.; Ito, K.; Itabashi, K.; Kuroda, K. One-step exfoliation of kaolinites and their transformation into nanoscrolls. Langmuir 2011, 27 (5), 2028-2035. DOI: 10.1021/la1047134
[36]. Detellier, C.; Letaief, S. Chapter 13.2—Kaolinite-Polymer Nanocomposites. In Developments in Clay Science, Vol. 5; Elsevier, 2013; pp 707-719. DOI: 10.1016/B978-0-08-098258-8.00022-5
[37]. Huang, X.; Li, Y.; Yin, X.; Tian, J.; Wu, W. Liquid-phase exfoliation of kaolinite by high-shear mixer with graphite oxide as an amphiphilic dispersant. Langmuir 2019, 35 (43), 13833-13843. DOI: 10.1021/acs.langmuir.9b02236
[38]. Huang, X.; Wu, W. Research and application of graphite oxide-assisted high-gravity rotating bed liquid phase exfoliation of kaolinite. Chemical Papers 2023, 77 (2), 745-755. DOI: 10.1007/s11696-022-02476-7
[39]. Evans, J.; Vincent, C. A.; Bruce, P. G. Electrochemical measurement of transference numbers in polymer electrolytes. Polymer 1987, 28 (13), 2324-2328. DOI: 10.1016/0032-3861 (87) 90394-6
[40]. Madejova, J. FTIR techniques in clay mineral studies. Vibrational Spectroscopy 2003, 31 (1), 1-10. DOI: 10.1016/S0924-2031 (02) 00065-6
[41]. Bich, C.; Ambroise, J.; Péra, J. Influence of degree of dehydroxylation on the pozzolanic activity of metakaolin. Applied Clay Science 2009, 44 (3), 194-200. DOI: 10.1016/j.clay.2009.01.014
[42]. Alarco, P.-J.; Abu-Lebdeh, Y.; Abouimrane, A.; Armand, M. The plastic-crystalline phase of succinonitrile as a universal matrix for solid-state ionic conductors. Nat. Mater. 2004, 3 (7), 476-481. DOI: 10.1038/nmat1158
[43]. Duncan, H.; Salem, N.; Abu-Lebdeh, Y. Electrolyte formulations based on dinitrile solvents for high voltage Li-ion batteries. J. Electrochem. Soc. 2013, 160 (6), A838. DOI: 10.1149/2.088306jes
[44]. Zhang, Q.; Liu, K.; Ding, F.; Li, W.; Liu, X.; Zhang, J. Safety-reinforced succinonitrile-based electrolyte with interfacial stability for high-performance lithium batteries. ACS Appl. Mater. Interfaces 2017, 9 (35), 29820-29828. DOI: 10.1021/acsami.7b09119
[45]. Fu, C.; Ma, Y.; Lou, S.; Cui, C.; Xiang, L.; Zhao, W.; Zuo, P.; Wang, J.; Gao, Y.; Yin, G. A dual-salt coupled fluoroethylene carbonate succinonitrile-based electrolyte enables Li-metal batteries. J. Mater. Chem. A 2020, 8 (4), 2066-2073. DOI: 10.1039/C9TA11341J
[46]. Zhang, Q.; Liu, K.; Ding, F.; Li, W.; Liu, X.; Zhang, J. Enhancing the high voltage interface compatibility of LiNi0.5Co0.2Mn0.3O2 in the succinonitrile-based electrolyte. Electrochim. Acta 2019, 298, 818-826. DOI: 10.1016/j.electacta.2018.12.104
[47]. Kam, W.; Licw, C.-W.; Lim, J. Y.; Ramesh, S. Electrical, structural, and thermal studies of antimony trioxide-doped poly(acrylic acid)-based composite polymer electrolytes. Ionics 2014, 20 (5), 665-674. DOI: 10.1007/s11581-013-1012-0
[48]. Shen, Y.; Deng, G.-H.; Ge, C.; Tian, Y.; Wu, G.; Yang, X.; Zheng, J.; Yuan, K. Solvation structure around the Li+ ion in succinonitrile-lithium salt plastic crystalline electrolytes. Phys. Chem. Chem. Phys. 2016, 18 (22), 14867-14873. DOI: 10.1039/C6CP02878K
[49]. Rajendran, S.; Kannan, R.; Mahendran, O. Ionic conductivity studies in poly(methylmethacrylate)-polyethlene oxide hybrid polymer electrolytes with lithium salts. J. Power Sources 2001, 96 (2), 406-410. DOI: 10.1016/S0378-7753 (00) 00573-5
[50]. Izadifar, M.; Thissen, P.; Steudel, A.; Kleeberg, R.; Kaufhold, S.; Kaltenbach, J.; Schuhmann, R.; Dehn, F.; Emmerich, K. Comprehensive examination of dehyroxylation of kaolinite, and dickite: Experimental studies and density functional theory. Clays Clay Miner. 2020, 68 (4), 319-333. DOI: 10.1007/s42860-020-00082-w
[51]. Zhang, H.; Ma, X.; Lin, C.; Zhu, B. Gel polymer electrolyte-based on PVDF/fluorinated amphiphilic copolymer blends for high performance lithium-ion batteries. RSC Adv. 2014, 4 (64), 33713-33719. DOI: 10.1039/C4RA04443F
[52]. Abouimrane, A.; Davidson, I. J. Solid electrolyte based on succinonitrile and LiBOB: Interface stability and application in lithium batteries. J. Electrochem. Soc. 2007, 154 (11), A1031. DOI: 10.1149/1.2781305
[53]. Lv, P.; Li, Y.; Wu, Y.; Liu, G.; Liu, H.; Li, S.; Tang, C.; Mei, J.; Li, Y. Robust succinonitrile-based gel polymer electrolyte for lithium-ion batteries withstanding mechanical folding and high temperature. ACS Appl. Mater. Interfaces 2018, 10 (30), 25384-25392. DOI: 10.1021/acsami.8b06800
[54]. Liu, K.; Zhang, Q.; Thapaliya, B. P.; Sun, X.-G.; Ding, F.; Liu, X.; Zhang, J.; Dai, S. In situ polymerized succinonitrile-based solid polymer electrolytes for lithium ion batteries. Solid State Ionics 2020, 345, 115159. DOI: 10.1016/j.ssi.2019.115159
[55]. Bi, J.; Mu, D.; Wu, B.; Fu, J.; Yang, H.; Mu, G.; Zhang, L.; Wu, F. A hybrid solid electrolyte Li0.33La0.557TiO3/poly(acylonitrile) membrane infiltrated with a succinonitrile-based electrolyte for solid state lithium-ion batteries. J. Mater. Chem. A 2020, 8 (2), 706-713. DOI: 10.1039/C9TA08601C
[56]. Han, D.; Wang, P.; Li, P.; Shi, J.; Liu, J.; Chen, P.; Zhai, L.; Mi, L.; Fu, Y. Homogeneous and fast Li-ion transport enabled by a novel metal-organic-framework-based succinonitrile electrolyte for dendrite-free Li deposition. ACS Appl. Mater. Interfaces 2021, 13 (44), 52688-52696. DOI: 10.1021/acsami.1c16498
[57]. Lee, M. J.; Han, J.; Lee, K.; Lee, Y. J.; Kim, B. G.; Jung, K.-N.; Kim, B. J.; Lee, S. W. Elastomeric electrolytes for high-energy solid-state lithium batteries. Nature 2022, 601 (7892), 217-222. DOI: 10.1038/s41586-021-04209-4
[58]. Polymer nanocomposites for lithium battery applications (2006), US20060231808A1.
[59]. Lithium-ion battery including polymer electrolyte composite material (2007), KR100722835B1.
[60]. Composite solid electrolyte including lithium iron phosphate (2019), WO2019226674A1.
[61]. Polymer-clay nanocomposite electrolyte for secondary battery and method for preparing the same (2022), KR102583474B1.
[62]. Paste electrolyte and rechargeable lithium battery containing the same (2007), KR100754421 B1.
[63]. Clay-based energy storage compositions for high temperature applications (2014), US20140315096A1.
[64]. Aqueous zinc ion battery colloidal electrolyte and preparation method and application thereof (2021), CN109980302B.

What is claimed is:

1. A method for scalable production of kaolinite nanoplatelets (KNPs), comprising:
shear-mixing a mixture of bulk kaolinite with ethanol or water and a dispersing agent;
centrifuging the shear-mixed mixture to sediment and remove unexfoliated bulk kaolinite, and obtain a supernatant containing the KNPs;
flocculating the supernatant with deionized (DI) water or sodium chloride solution, collecting and drying flocculated KNPs; and
annealing the flocculated KNPs to decompose and volatilize the remaining dispersing agent, thereby resulting in a partial coating of oxidized amorphous carbon on the surface of the KNPs.

2. The method of claim 1, wherein said flocculating the supernatant with deionized (DI) water is performed at a mass ratio of supernatant:DI water being about 1.5:1 to 1.75:1.

3. The method of claim 1, wherein said flocculating the supernatant with aqueous sodium chloride solution is performed at a mass ratio of supernatant:DI water being about 1.5:1 to 1.75:1.

4. The method of claim 1, wherein said annealing the flocculated KNPs is performed in air at about 400° C. for 4 h.

5. The method of claim 1, wherein the dispersing agent is adapted to minimize re-agglomeration of the aluminosilicate layers.

6. The method of claim 1, wherein the dispersing agent comprises ethyl cellulose (EC), carboxymethyl cellulose (CMC), hydroxyethyl cellulose (HEC), hydroxypropyl methylcellulose (HPMC), hydroxypropyl cellulose (HPC), cellulose acetate (CA), or polyethylene glycol (PEG).

7. The method of claim 6, wherein yield of the KNPs from the bulk kaolinite after liquid phase exfoliation has an approximately linear relationship with a starting ratio of the EC to the bulk kaolinite.

8. The method of claim 7, wherein the starting ratio of the EC to the bulk kaolinite is less than about 0.5:1 (EC:kaolinite).

9. The method of claim 1, further comprising recycling the sediment of unexfoliated bulk kaolinite, which generates an increase in yield of the KNPs about 20% compared to using fresh bulk kaolinite alone.

10. The method of claim 1, wherein the KNPs have a hexagonal plate-like morphology.

11. The method of claim 1, wherein the KNPs have an average lateral size and thickness of about 190±50 nm and about 17±5 nm, respectively.

12. The method of claim 11, wherein the distribution of the nanoplatelet thicknesses has a median thickness of about 3 nm with about 35% of the KNPs having a thickness less than about 2 nm.

13. The method of claim 1, wherein the XRD diffraction pattern for the KNPs shows a significantly diminished (001) reflection when compared to the (002) reflection, thereby verifying a significant disruption of the stacking periodicity of kaolinite layers following exfoliation.

14. The method of claim 1, wherein Fourier-transform infrared spectroscopy (FTIR) spectra of the KNPs have a blue shift in vibrational frequency in the hydroxyl and Si—O peaks compared to that of the bulk kaolinite.

15. The method of claim 1, wherein all peaks in the KNP spectrum are mappable to the bulk kaolinite structure with the exception of a broad peak at 1440 cm⁻¹, which is attributed the C—O and C—H stretching from the annealed EC on the nanoplatelet surface.

16. The method of claim 1, wherein the KNPs have the Brunauer-Emmett-Teller (BET) surface area more than doubled from about 9.7 m² g⁻¹ to about 24 m² g⁻¹ following kaolinite exfoliation.

17. The method of claim 1, wherein the KNPs have excellent thermal stability with measurable mass loss only detectable at temperatures exceeding about 500° C.

18. The method of claim 1, wherein the KNPs have limited of kaolinite nanoscroll morphology.

19. The method of claim 1, wherein the KNPs have high specific surface area relative to that of the bulk kaolinite, which facilitates strong gelation with liquid electrolytes at low mass loadings.

20. The method of claim 1, wherein the KNPs is dispersible with a liquid electrolyte to form a high-performance gel electrolyte.

21. Kaolinite nanoplatelets (KNPs), produced according to the method of claim 1.

22. A nanocomposite gel electrolyte, comprising:
a succinonitrile-based (SN), dinitrile-based, ether-based, ethylene carbonate-based, propylene carbonate-based or ionic liquid-based liquid electrolyte; and
kaolinite nanoplatelets (KNPs) mixed with the liquid electrolyte to form a KNP-SN gel electrolyte, denoted as KNP(x %)-SN, wherein x is a mass percentage of the KNPs in the KNP-SN gel electrolyte, wherein the KNPs are produced according to the method of claim 1.

23. The nanocomposite gel electrolyte of claim 22, wherein the KNP-SN gel electrolyte possesses a range of superlative properties including high room-temperature ionic conductivity (1 mS cm⁻¹), stiff storage modulus (>10 MPa), wide electrochemical stability window (4.5 V vs. Li/Li⁺), and excellent thermal stability (˜100° C.).

24. The nanocomposite gel electrolyte of claim 22, wherein the SN liquid electrolyte comprises SN mixed with two lithium salts (lithium bis(trifluoromethanesulfonyl)imide (LiTFSI) and lithium tetrafluoroborate (LiBF₄)) along with a film-forming additive, fluoroethylene carbonate (FEC).

25. The nanocomposite gel electrolyte of claim 22, wherein FTIR spectra of the KNP-SN gel electrolyte have a blue shift of the interlayer hydroxyl group and Si—O vibrational bands as the relative SN content increases in the KNP-SN gel electrolyte.

26. The nanocomposite gel electrolyte of claim 22, being usable as both an electrolyte and a separator within LMB cells by preventing short-circuiting and inhibiting lithium dendrite growth.

27. The nanocomposite gel electrolyte of claim 22, wherein the KNP-SN gel electrolyte has a quasi-solid nature that is confirmed by the storage modulus being consistently higher than the loss modulus across a wide range of shear frequencies.

28. The nanocomposite gel electrolyte of claim 22, wherein the KNP-SN gel electrolyte possesses a high ionic conductivity of 1 mS cm⁻¹ at 20° C.

29. The nanocomposite gel electrolyte of claim 22, wherein the lithium transference number (T_{Li}) for the KNP-SN gel electrolyte is that 0.6.

30. The nanocomposite gel electrolyte of claim 22, wherein FTIR spectra of the KNP-SN gel electrolyte shows the blue shifting of the peaks associated with the asymmetric stretching of the —CF₃ groups within the TFSI anion and the carbonyl group of FEC as KNP content is increased, wherein the blue shifting is due to hydrogen bonding with exposed hydroxyl groups on the surface of the KNP.

31. The nanocomposite gel electrolyte of claim 22, wherein as the KNP loading increases, the relative area of the SN-Lit peak decreases, indicating that lithium is being solvated by other species, likely the exposed silica surface of the KNPs.

32. The nanocomposite gel electrolyte of claim 22, wherein the combined effect of Li salt interactions with the KNP surface accounts for the increase in lithium transference number of the KNP-SN gel compared to the SN-only liquid electrolyte.

33. The nanocomposite gel electrolyte of claim 22, wherein the KNP-SN gel electrolyte has an electronic conductivity of about 6.30×10⁻¹⁰ S cm⁻¹, which is sufficiently insulating for solid-state electrolytes (SSEs) in energy storage applications.

34. The nanocomposite gel electrolyte of claim 22, wherein the KNP-SN gel reaches 2% mass loss at 100° C. (T_{2%}), which represents significantly higher thermal stability than traditional carbonate electrolytes.

35. The nanocomposite gel electrolyte of claim 22, wherein the KNP-SN gel is electrochemically stable with lithium metal over a range of potentials up to 4.5 V vs. Li/Li⁺.

36. The nanocomposite gel electrolyte of claim 22, wherein the KNP-SN gel electrolyte is compatible for energy-dense LMBs, the electrochemical stability window was evaluated at both high and low potentials relative to Li/Li⁺.

37. An electrochemical device, comprising:
a positive electrode;
a negative electrode; and
a nanocomposite gel electrolyte disposed between the positive electrode and the negative electrode.

38. The electrochemical device of claim 37, wherein the nanocomposite gel electrolyte is a KNP-SN gel electrolyte comprising a succinonitrile (SN) liquid electrolyte and kaolinite nanoplatelets (KNPs) mixed with the SN liquid electrolyte.

39. The electrochemical device of claim 37, wherein the electrochemical device is a lithium metal battery (LMB).

40. The electrochemical device of claim 37, wherein the positive electrode is an LiFePO₄ (LFP), Li₄Ti₅O₁₂ (LTO), LiNi_{0.8}Co_{0.15}Al_{0.05}O₂ (NCA), LiNi_{0.33}Mn_{0.33}Co_{0.33}O₂ (NMC111), LiNi_{0.5}Mn_{0.3}Co_{0.2}O₂ (NMC532), LiNi_{0.6}Mn_{0.2}Co_{0.2}O₂ (NMC622), LiNi_{0.8}Mn_{0.1}Co_{0.1}O₂ (NMC811), LiNiO₂ (LNO), LiMn₂O₄ (LMO), or LiCoO₂ (LCO) positive electrode, and wherein the negative electrode is a lithium metal electrode.

41. The electrochemical device of claim 37, wherein when the positive electrode is with a high active material loading of greater than 10 mg cm⁻², both cell types achieve high discharge capacities of 160 mAh g⁻¹ and 200 mAh g⁻¹ at 0.1 C (0.18-0.2 mA cm⁻²) for LFP|Li and NCA|Li, respectively.

42. The electrochemical device of claim 37, wherein the LMB has excellent rate capability and >56% capacity utilization compared to 0.1 C.

43. The electrochemical device of claim 37, wherein the LMB has stable electrochemical operation.

44. The electrochemical device of claim 37, wherein the LMB reaches 125 cycles with a capacity retention of 94% and 80% for LFP|Li and NCA|Li, respectively.

45. The electrochemical device of claim 37, wherein the LMB has an improvement in rate of 12% and 22% for the LFP and NCA cells, respectively.

46. The electrochemical device of claim 37, wherein the LMBs achieve excellent performance, particularly >56% capacity utilization up to a current density of 2 mA cm⁻².
